(19) United States
(12) Patent Application Publication
(10) Pub. No.: US 2014/0156690 A1
(43) Pub. Date: Jun. 5, 2014

(54) INFORMATION PROCESSING APPARATUS AND METHOD AND NON-TRANSITORY COMPUTER READABLE MEDIUM

(71) Applicant: Fuji Xerox Co., Ltd., Tokyo (JP)

(72) Inventors: Tomoyuki ITO, Kanagawa (JP); Michiaki YASUNO, Kanagawa (JP); Hiroshi UMEMOTO, Kanagawa (JP); Satoru INAKAGE, Kanagawa (JP)

(73) Assignee: Fuji Xerox Co., Ltd., Tokyo (JP)

(21) Appl. No.: 13/892,581

(22) Filed: May 13, 2013

(30) Foreign Application Priority Data
Dec. 5, 2012 (JP) 2012-266807

(51) Int. Cl. G06F 17/30

(52) U.S. Cl. CPC G06F 17/30277
USPC 707/758

(57) ABSTRACT

An information processing apparatus includes the following elements. A first selector selects, through a selecting operation performed by an operator, an item disposed within a QFD chart, the QFD chart having at least three axes, an item being associated with each of the axes, a name being appended to each of the axes, and a name being appended to each of the items. A second selector selects, through a selecting operation performed by the operator, information related to the item selected by the first selector. An appending unit appends a name of an axis corresponding to the item selected by the first selector and a name of the item to the information selected by the second selector.

### CROSS-REFERENCE TO RELATED APPLICATIONS

This application is based on and claims priority under 35 USC 119 from Japanese Patent Application No. 2012-266807 filed Dec. 5, 2012.

### BACKGROUND

### Technical Field

The present invention relates to an information processing apparatus and method, and a non-transitory computer readable medium.

### SUMMARY

According to an aspect of the invention, there is provided an information processing apparatus including: a first selector that selects, through a selecting operation performed by an operator, an item disposed within a QFD chart, the QFD chart having at least three axes, an item being associated with each of the axes, a name being appended to each of the axes, and a name being appended to each of the items; a second selector that selects, through a selecting operation performed by the operator, information related to the item selected by the first selector; and an appending unit that appends a name of an axis corresponding to the item selected by the first selector and a name of the item to the information selected by the second selector.

### BRIEF DESCRIPTION OF THE DRAWINGS

Exemplary embodiments of the present invention will be described in detail based on the following figures, wherein:

FIG. 1 is a block diagram illustrating conceptual modules forming an information processing apparatus according to a first exemplary embodiment;

FIG. 2 illustrates a system configuration for implementing the first exemplary embodiment;

FIG. 3 illustrates an example of a Quality Function Deployment (QFD) chart to be processed by the first exemplary embodiment;

FIG. 4 is a flowchart illustrating an example (I) of registration processing according to the first exemplary embodiment;

FIG. 5 is a flowchart illustrating an example (1) of search processing according to the first exemplary embodiment;

FIG. 6 is a flowchart illustrating an example (2) of registration processing according to the first exemplary embodiment;

FIG. 7 is a flowchart illustrating an example (2) of search processing according to the first exemplary embodiment;

FIG. 8 is a block diagram illustrating conceptual modules forming an information processing apparatus according to a second exemplary embodiment;

FIG. 9 is a flowchart illustrating an example of registration processing according to the second exemplary embodiment;

FIG. 10 is a flowchart illustrating an example of search processing according to the second exemplary embodiment;

FIG. 11 is a block diagram illustrating conceptual modules forming an information processing apparatus according to a third exemplary embodiment;

FIG. 12 is a flowchart illustrating an example of processing according to the third exemplary embodiment;

FIG. 13 illustrates an example of the data structure of an axis item table;

FIG. 14 illustrates an example of processing for displaying and selecting axis names;

FIG. 15 illustrates an example of processing for displaying and selecting axis items;

FIG. 16 illustrates a display example of a selected axis name and selected items;

FIG. 17 illustrates a display example of a parts/members QFD chart;

FIG. 18 illustrates a display example of a system QFD chart;

FIG. 19 is a flowchart illustrating another example of processing according to the third exemplary embodiment; and

FIG. 20 illustrates an example of the hardware configuration of a computer implementing an exemplary embodiment.

### DETAILED DESCRIPTION

Prior to a description of exemplary embodiments of the present invention, a technology which serves as a base of the exemplary embodiments will first be discussed. This discussion will be given for the purpose of easy understanding of the exemplary embodiments.

As the structure of a technology or a product becomes complicated, the number of cause-and-effect relationships between factors forming the technology or the product becomes increasing, and also, the cause-and-effect relationships are interacted with each other. It is thus difficult to understand the associations between factors. This may bring about the following problems.

(1) It takes time to find cause-and-effect relationships between factors of a technology or a product, thereby decreasing the efficiency in designing and developing the technology or the product.

(2) It is more likely to overlook a problem, and when a problem is found, a designing or developing process has to be suspended and reexamined.

(3) If manufacturing of a product continues without realizing the existence of a problem, quality problems occur.

(4) If an unexpected problem occurs, it takes time to construct a technology for analyzing a phenomenon of the problem, which causes a delay in addressing the problem.

One of the measures to be taken against the above-described problems which may effectively function is a method of analyzing and visualizing factors based on Quality Function Deployment (QFD).

QFD is a method for clarifying targets, problems, and actions to be taken so that customer/client requirements in terms of the quality can be reflected in product manufacturing in various stages, such as product planning, product developing, etc.

A typical form of QFD is a matrix indicating relationships between items of “quality requirements” extracted from items of customer/client requirements and items of “quality characteristics” extracted from factors to be considered in terms of a technology. QFD may also represent relationships between items of “quality requirements” or items of “quality characteristics” in the form of a triangle attic. By applying weights to items of “quality requirements”, items of “planning requirements” (indicating which characteristics will satisfy customers/clients) may be extracted. Also, by associating items of “quality characteristics” with product design values, items of “design requirements” (product specifications) can be extracted. As a result of examining the above-described relationships, relationships among targets, problems, and actions to be taken can be clarified. That is, a QFD chart is a chart in which plural item lists are deployed on axes orthogonal to each other and cause-and-effect relationships between items on adjacent axes are represented in the form of a matrix.

In order to improve QFD, the following proposal has been made. Not only the use of items of “quality requirements” and “quality characteristics”, but also various deployments, such as “parts deployment”, “technology deployment”, and “task deployment”, are performed according to the circumstances, and then, obtained cause-and-effect relationships between items are represented by two-dimensional tables. Moreover, a computer program for displaying these tables is produced, and the items and matrix cells are linked to information on a network, thereby utilizing QFD as a frame for storing and sharing information.

However, some products, such as printers and medical instruments, function in a complicated manner such that many parts/members and plural physical phenomena are interrelated with each other. In the development of such a product, there are a huge number of items to be handled, and also, it is difficult to sufficiently describe relationships between design characteristics and quality requirements by using a simple frame, such as a combination of “quality requirements” and “quality characteristics” or a combination of “parts deployment” and “technology deployment”. Moreover, a process for manufacturing a product is established in coordination of many departments, such as technology development, parts/members development, system development, and manufacturing departments. Accordingly, two-dimensional tables may be created, and symbols representing that “these items may be related” and “these items may not be related” may be assigned. However, unless the entire relationships between design characteristics and quality requirements including a mechanism of a phenomenon “why these items may be related” or “why these items may not be related” can be understood at a glance, it is difficult to utilize QFD in an actual designing and developing process. That is, the manufacturing steps for parts and members and the quality of a manufactured product are indirectly related to each other with various intermediate characteristics therebetween. Unless tables having appropriate intermediate characteristics and configurations are provided, it is difficult to clarify relationships between the manufacturing steps and the quality. The product design conditions and the product quality are also indirectly related to each other with various intermediate characteristics therebetween. Unless tables having appropriate intermediate characteristics and configurations are provided, it is difficult to clarify the relationships between the design conditions and the quality.

Additionally, in many cases, the definition of intermediate characteristics is ambiguous, which makes it difficult to standardize QFD charts. As a result, the use of QFD charts in an actual designing and developing process has not been promoted.

The above-described problems may be addressed by preparing a system which implements the following operations. A cause-and-effect relationship table having axes indicating appropriately defined intermediate characteristics is created. Then, such cause-and-effect relationships are displayed such that the entire relationships between intermediate characteristics can be observed at a glance. The input of items, which are likely to be numerous, positioned on an axis and formation and display of matrices can also be easily performed. However, when cause-and-effect relationships between phenomena become complicated to a certain degree, it is not possible to cover sufficient information even with a multi-axis table, such as a three-axis table or a table having a greater number of axes. For example, even if a table indicates that there is a cause-and-effect relationship between items, a more detailed explanation concerning the cause of the relationship may sometimes become necessary. Moreover, in order to understand a cause-and-effect relationship, it may be necessary to obtain experiment/calculation data, which serves as grounds for the cause-and-effect relationship. It may also be necessary to obtain information concerning how items on an axis can be measured or analyzed in order to obtain such experiment/calculation data. In order to address such problems, the following system is available. In this system, pieces of information are stored in storage regions in a computer or on a network, and the pieces of information stored in the storage regions are associated with corresponding portions of a multi-axis table. Then, when a corresponding portion is selected, a necessary piece of information can be obtained or viewed.

However, sharing of pieces of information associated with items or elements on multi-axis tables is problematic. This will be discussed more specifically. It is now assumed that a certain piece of reference information stored in a storage region of a computer or a network is associated with an item or an element of a multi-axis table which is being created or being viewed by a user. In this case, if there is the same item or the same cause-and-effect relationship in another multi-axis table which is being created by the same user, a multi-axis table which is being created by another user, or an already created multi-axis table, it is desirable that this piece of reference information be referred to by all the multi-axis tables. However, the configurations of multi-axis tables are not uniform, and thus, it is difficult to share reference information by the related art. According to an exemplary embodiment of the present invention, necessary pieces of reference information can be widely shared by using a multi-axis table in which complicated cause-and-effect relationships can be easily understood at a glance. As a result, it is possible to implement efficient design and development without causing omissions and errors.

Exemplary embodiments of the present invention will be described below with reference to the accompanying drawings.

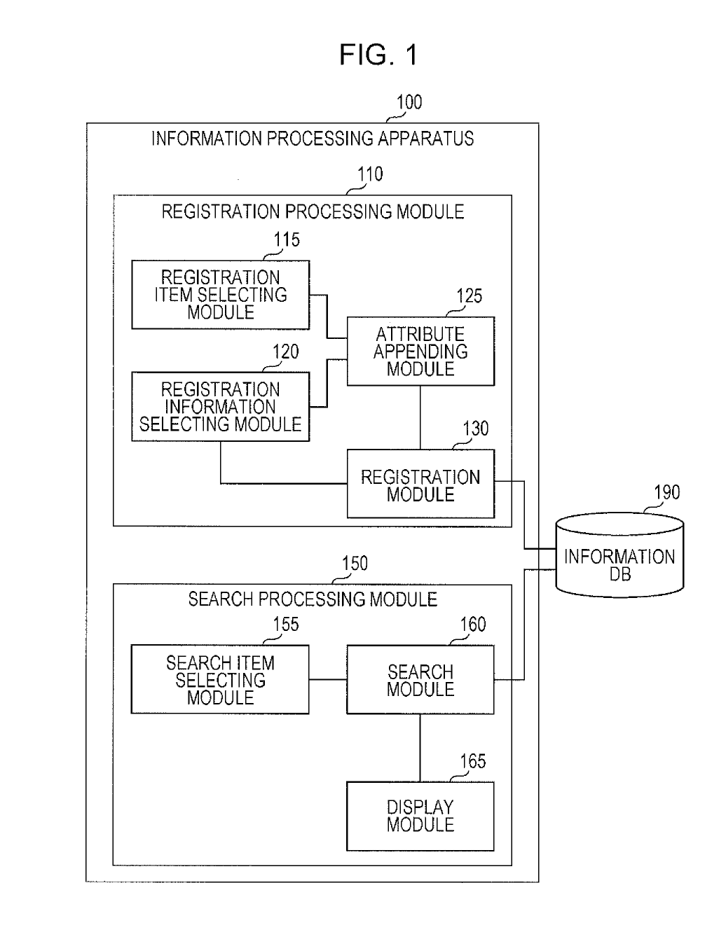

FIG. 1 is a block diagram illustrating conceptual modules forming an information processing apparatus 100 according to a first exemplary embodiment.

Generally, modules are software (computer programs) components or hardware components that can be logically separated from one another. Accordingly, the modules of exemplary embodiments of the invention are not only modules of a computer program, but also modules of a hardware configuration. Thus, the exemplary embodiments will also be described in the form of a computer program for allowing a computer to function as those modules (a program for causing a computer to execute program steps, a program for allowing a computer to function as corresponding units, a computer program for allowing a computer to implement corresponding functions), a system, and a method. While expressions such as “store”, “storing”, “being stored”, and equivalents thereof are used for the sake of description, such expressions indicate, when the exemplary embodiments relate to a computer program, storing the computer program in a storage device or performing control so that the computer program is stored in a storage device. Modules may correspond to functions based on a one-on-one relationship. In terms of implementation, however, one module may be constituted by one program, or plural modules may be constituted by one program. Conversely, one module may be constituted by plural programs. Additionally, plural modules may be executed by using a single computer, or one module may be executed by using plural computers in a distributed or parallel environment. One module may integrate another module therein. Hereinafter, the term “connection” includes not only physical connection, but also logical connection (sending and receiving of data, giving instructions, reference relationship among data elements, etc.). The term “predetermined” means being determined prior to a certain operation, and includes the meaning of being determined prior to a certain operation before starting processing of the exemplary embodiments, and also includes the meaning of being determined prior to a certain operation even after starting processing of the exemplary embodiments, in accordance with the current situation/state or in accordance with the previous situation/state. If there are plural “predetermined values”, they may be different values, or two or more of the values (or all the values) may be the same. A description having the meaning “in the case of A, B is performed” is used as the meaning “it is determined whether case A is satisfied, and B is performed if it is determined that case A is satisfied”, unless such a determination is necessary.

A system or an apparatus may be realized by connecting plural computers, hardware units, devices, etc., to one another via a communication medium, such as a network (including communication based on a one-on-one correspondence), or may be realized by a single computer, hardware unit, device, etc. The terms “apparatus” and “system” are used synonymously. The term “system” does not include merely a man-made social “mechanism” (social system).

Additionally, every time an operation is performed by using a corresponding module or every time each of plural operations is performed by using a corresponding module, target information is read from a storage device, and after performing the operation, a processed result is written into the storage device. Accordingly, a description of reading from the storage device before an operation or writing into the storage device after an operation may be omitted. Examples of the storage device may be a hard disk, a random access memory (RAM), an external storage medium, a storage device using a communication line, a register within a central processing unit (CPU), etc.

The information processing apparatus 100 of the first exemplary embodiment includes, as shown in FIG. 1, a registration processing module 110 and a search processing module 150. The registration processing module 110 and the search processing module 150 are connected to an information database (DB) 190. The information processing apparatus 100 may be constituted by only one of the registration processing module 110 and the search processing module 150.

The information processing apparatus 100 is utilized for supporting design and development in order to improve the efficiency in developing technologies and products and also to enhance the qualities of technologies and products. More specifically, the information processing apparatus 100 is utilized for creating a QFD chart.

The registration processing module 110 includes a registration item selecting module 115, a registration information selecting module 120, an attribute appending module 125, and a registration module 130. The registration processing module 110 registers information related to items disposed within an each axis in the information DB 190.

The registration item selecting module 115 is connected to the attribute appending module 125. The registration item selecting module 115 selects, through a selecting operation performed by a user, an item described in a QFD chart. The QFD chart includes at least three axes, and items are associated with each of the axes. An axis name is appended to each of the axes, and an item name is appended to each item. An example of such a QFD chart is a QFD chart 300 shown in FIG. 3. In this example, as a QFD chart including three or more axes, a QFD chart having four axes is shown. More specifically, the QFD chart 300 is constituted by four axes (a first axis 310, a second axis 320, a third axis 330, and a fourth axis 340). In each of the first through fourth axes 310 through 340, an axis name of an associated axis is indicated. Each of the first through fourth axes 310 through 340 includes at least one item, and an item name is appended to the item. For example, as the name of the first axis 310, “quality” is appended, as the name of the second axis 320, “performance” is appended, as the name of the third axis 330, “structures and physical properties” is appended, and as the name of the fourth axis 340, “production conditions” is appended. Items are associated with the first axis 310, and as the names of these items, for example, “cooks quickly and cooks large quantities”, “easy to use”, etc., are appended.

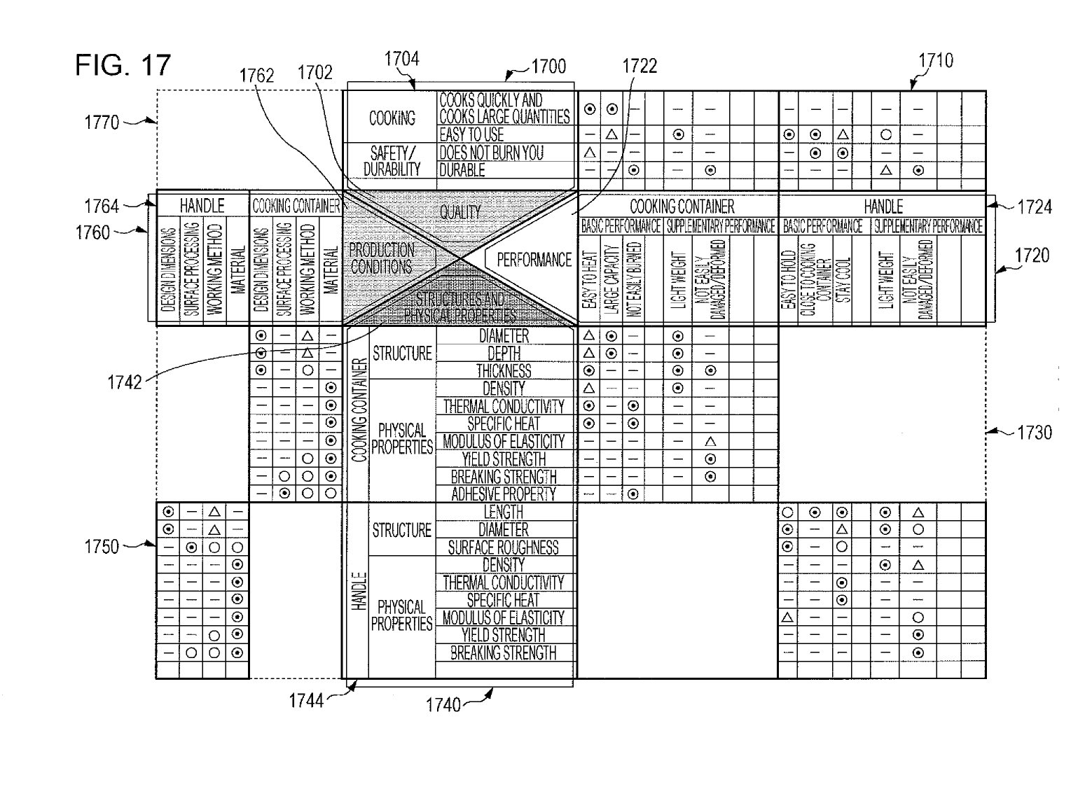

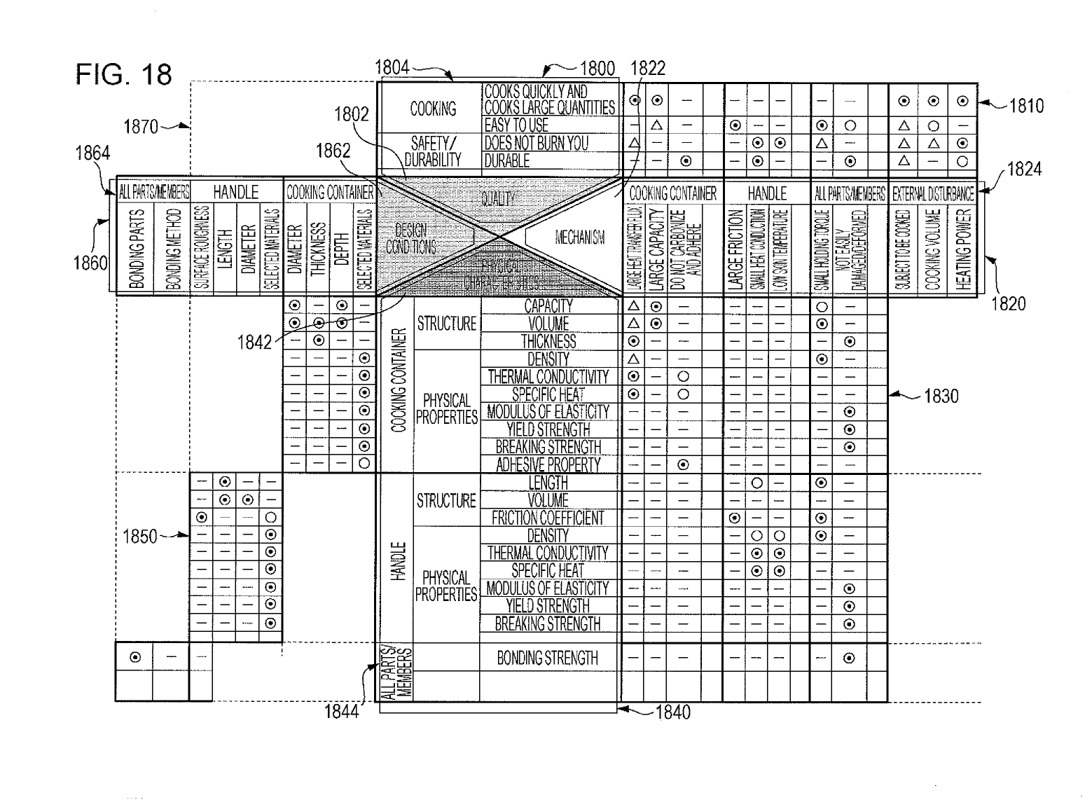

A first-axis/second-axis correlation matrix 315 is provided between the first axis 310 and the second axis 320. A second-axis/third-axis correlation matrix 325 is provided between the second axis 320 and the third axis 330. A third-axis/fourth-axis correlation matrix 335 is provided between the third axis 330 and the fourth axis 340. That is, the first-axis/second-axis correlation matrix 315 is defined by the first axis 310 and the second axis 320. The second-axis/third-axis correlation matrix 325 is defined by the second axis 320 and the third axis 330. The third-axis/fourth-axis correlation matrix 335 is defined by the third axis 330 and the fourth axis 340. QFD charts will be described later more specifically with reference to FIGS. 17 and 18.

An example of a QFD chart having three axes may be a QFD chart constituted by the first axis 310, the second axis 320, and the third axis 330 or a QFD chart constituted by the second axis 320, the third axis 330, and the fourth axis 340.

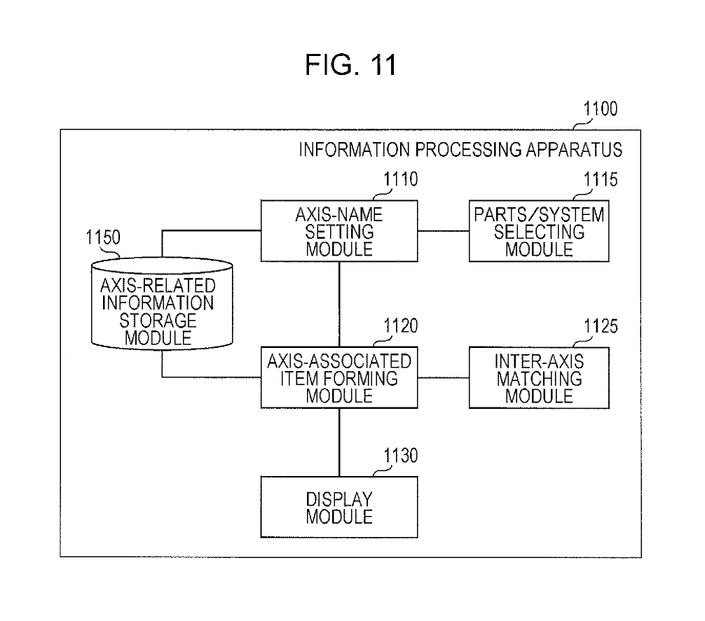

The selection of an item described in a QFD chart is performed as follows. A QFD chart is displayed on a display device, such as a display, and an operator selects an item disposed within an axis of the QFD chart by using a mouse, a touch panel, etc. The creation and display of a QFD chart will be discussed later with reference to FIGS. 11 through 16.

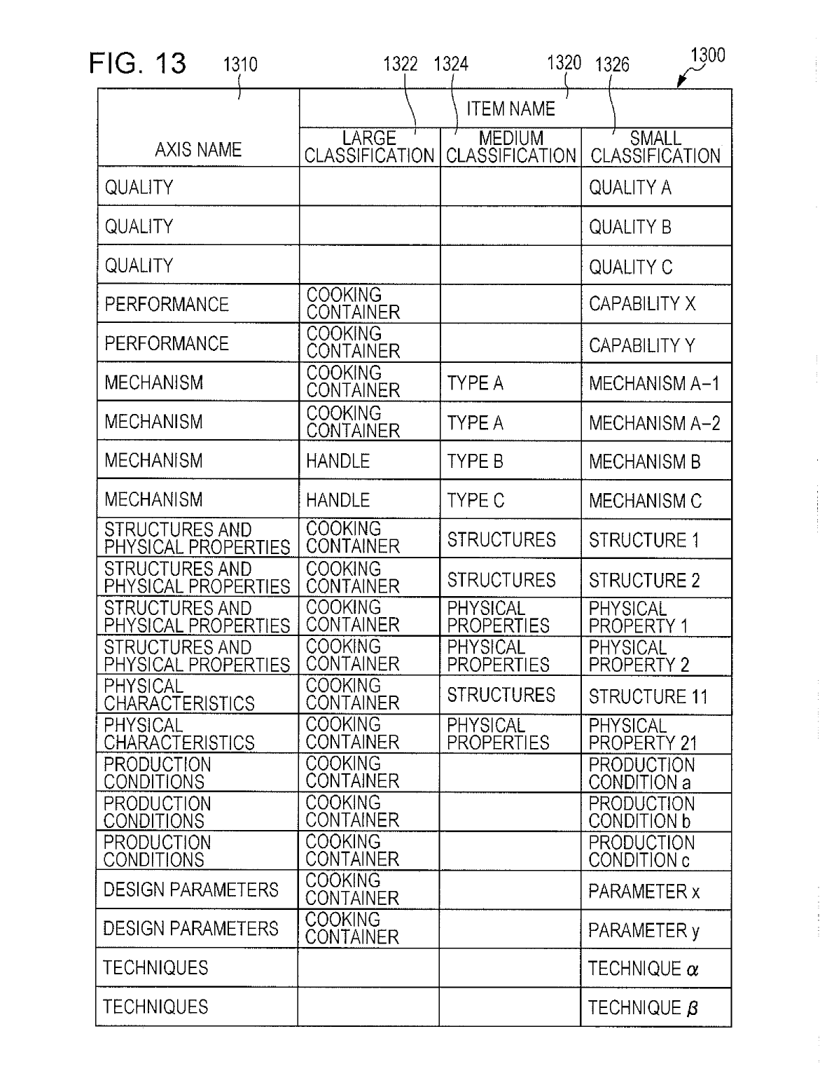

Axis names, item names, and a data structure indicating relationships between the axis names and item names will be discussed later with reference to an example shown in FIG. 13.

The registration information selecting module 120 is connected to the attribute appending module 125 and the registration module 130. The registration information selecting module 120 selects, through a selecting operation performed by a user, information related to an item selected by the registration item selecting module 115. An example of information is a document. A document is text data, or digital data, such as images, moving pictures, audio, etc., or a combination thereof. The document is a subject to be stored, edited, or searched for, and can be exchanged among systems or users as an individual unit to be processed. The document also includes equivalents of such a subject. For example, the registration information selecting module 120 selects a document used for forming an item, through an operation performed by a user by using a mouse, a touch panel, etc.

The attribute appending module 125 is connected to the registration item selecting module 115, the registration information selecting module 120, and the registration module 130. The attribute appending module 125 appends the name of an item selected by the registration item selecting module 115 and the name of an axis of the item to information selected by the registration information selecting module 120. In this case, the axis name and the item name may be appended, for example, as follows. Two attributes may be prepared as attributes of a document, and the axis name and the item name may be set to be the two respective attributes. Alternatively, the axis name may be set as the name of the document, and the item name may be set as an attribute. If items are formed in a hierarchical structure, the name of an item in a certain level of the hierarchical structure may be used, or the names of items in two or more levels may be used.

The registration module 130 is connected to the registration information selecting module 120, the attribute appending module 125, and the information DB 190. The registration module 130 registers information to which an axis name and an item name are appended by the attribute appending module 125 in the information DB 190. With this registration processing, the registered information can be searched for by the search processing module 150.

The search processing module 150 includes a search item selecting module 155, a search module 160, and a display module 165. The search processing module 150 searches the information DB 190 for information related to an item disposed within each axis.

The search item selecting module 155 is connected to the search module 160. The search item selecting module 155 selects, through a selecting operation performed by a user, an item described in a QFD chart. The selecting operation performed by the search item selecting module 155 is similar to that performed by the registration item selecting module 115. However, an item selected by the search item selecting module 155 is used for searching for information related to the selected item.

The search module 160 is connected to the search item selecting module 155, the display module 165, and the information DB 190. The search module 160 searches, on the basis of the name of an item selected by the search item selecting module 155 and the name of the axis of this item, the information DB 190 for information to which the axis name and the item name are appended by the registration processing module 110. That is, the search module 160 searches the information DB 190 for information to which attributes having the same axis name and the same item name as those of the item selected by the search item selecting module 155 are appended. If the item selected by the search item selecting module 155 is formed as part of a hierarchical structure, the search module 160 may search for information to which the names of items in the individual levels of the hierarchical structure that perfectly coincide with those of the items selected by the search item selecting module 155 are appended. Alternatively, the search module 160 may search for information to which the name of an item in any one of the hierarchical levels that coincides with that of the item selected by the search item selecting module 155 is appended. A search may be conducted under the conditions that, not only the name of an item, but also the level of this item in a hierarchical structure, coincide with those of the item selected by the search item selecting module 155.

The display module 165 is connected to the search module 160. The display module 165 displays information searched by the search module 160 on a display device, such as a display. In this case, the display module 165 displays information so as to indicate that the information is related to an item selected by the search item selecting module 155. For example, the display module 165 displays the information near the item, or within a region connected to the item with a line.

The information DB 190 is connected to the registration module 130 and the search module 160. Within the information DB 190, information to which an axis name and an item name are appended is registered by the registration module 130. Then, the registered information is searched for by the search module 160 by using the axis name and the item name as keys.

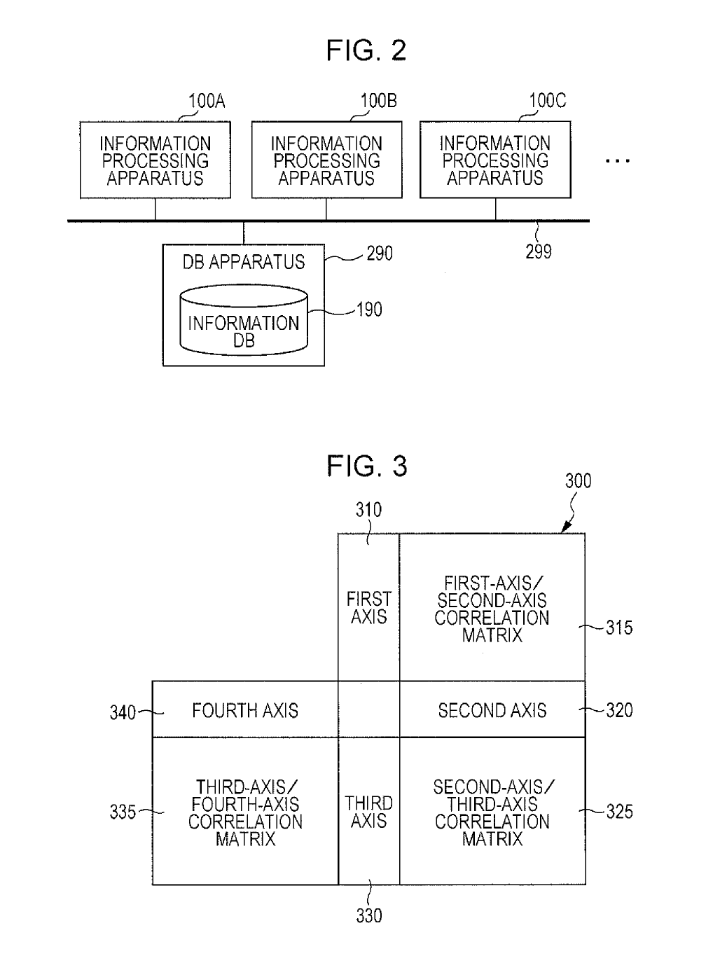

FIG. 2 illustrates a system configuration for implementing the first exemplary embodiment (or a combination of the first exemplary embodiment and a second exemplary embodiment or a third exemplary embodiment). The system configuration shown in FIG. 2 is a configuration in which items described in a QFD chart are associated with pieces of information stored in the information DB 190 and users are allowed to share these pieces of information.

Information processing apparatuses 100A, 100B, and 100C and a DB apparatus 290 are connected to one another with a communication line 299. The information processing apparatuses 100A, 100B, and 100C each correspond to the information processing apparatus 100 shown in FIG. 1. The DB apparatus 290 includes the information DB 190. For example, the information processing apparatus 100A associates, through an operation performed by an operator A, an item described in a QFD chart A with a document used for creating the QFD chart A. It is now assumed that an operator B creates a new QFD chart B. In this case, the information processing apparatus B selects, through an operation performed by the operator B, an item within the QFD chart B, and then searches for information associated with an item having the same axis name and the same item name in the QFD chart A as those of the item selected by the operator B. That is, when creating the QFD chart B, the operator B is able to refer to the same information as that referred to by the operator A when creating the QFD chart A. When the operator A creates a new QFD chart C, the information processing apparatus A selects, through an operation performed by the operator A, selects an item within the QFD chart C. Then, the information processing apparatus A searches for information associated with an item having the same axis name and the same item name in the QFD chart A as those of the selected item. That is, when creating the QFD chart C, the operator A is able to refer to the same information as that referred to by the operator A when creating the QFD chart A.

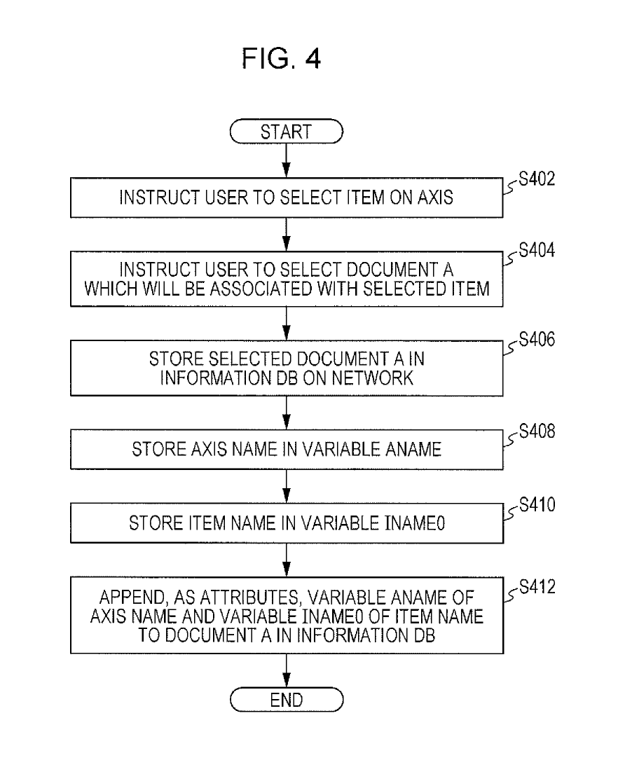

FIG. 4 is a flowchart illustrating an example (1) of registration processing according to the first exemplary embodiment. In this registration processing, information associated with an item is registered, but not together with a classification name in a hierarchical structure. More specifically, this processing is performed in a case in which items are not formed in a hierarchical structure (or items are classified under only one level of a hierarchical structure), or although items are formed in a hierarchical structure, only an item name in a predetermined level is used.

In step S402, the registration item selecting module 115 instructs a user to select an item on an axis.

In step S404, the registration information selecting module 120 instructs the user to select a document A, which will be associated with the item on the axis.

In step S406, the registration module 130 stores the selected document A in an information DB on a network.

In step S408, the attribute appending module 125 stores the name of the axis of the selected item in a variable ANAME.

In step S410, the attribute appending module 125 stores the name of the item in a variable INAME0.

In step S412, the registration module 130 appends, as attributes, the variable ANAME corresponding to the axis name and the variable INAME0 corresponding to the item name to the document A stored in the information DB.

In step S412, the name of the document A may be set as the variable ANAME, and the variable INAME corresponding to the item name may be appended as an attribute.

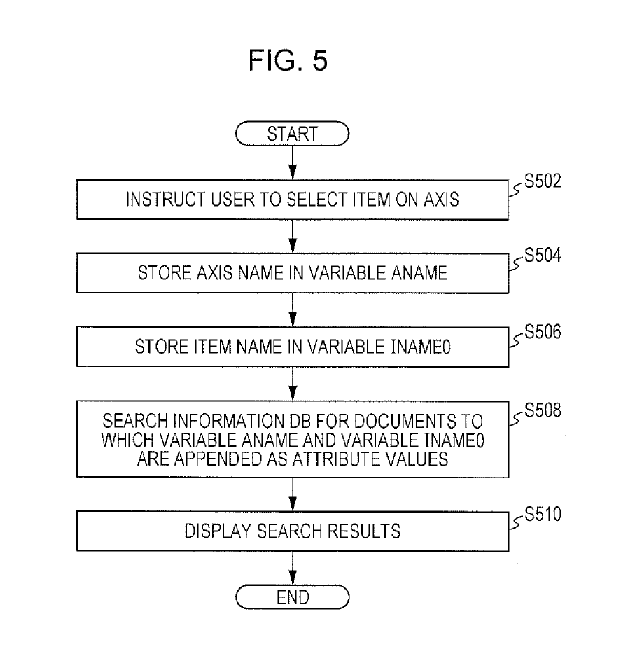

FIG. 5 is a flowchart illustrating an example (1) of search processing according to the first exemplary embodiment. In this search processing, information associated with an item is searched for, but not together with a classification name in a hierarchical structure.

In step S502, the search item selecting module 155 instructs a user to select an item on an axis.

In step S504, the search module 160 stores the name of the axis of the selected item in a variable ANAME.

In step S506, the search module 160 stores the name of the selected item in a variable INAME0.

In step S508, the search module 160 searches the information DB for documents to which the variable ANAME and the variable INAME0 are appended as attribute values.

In step S510, the display module 165 displays search results.

If, in the registration processing, the name of the document has been set as the variable ANAME and the variable INAME0 has been appended as an attribute, in step S508, the search module 160 searches for a document of the variable ANAME to which the variable INAME0 is appended.

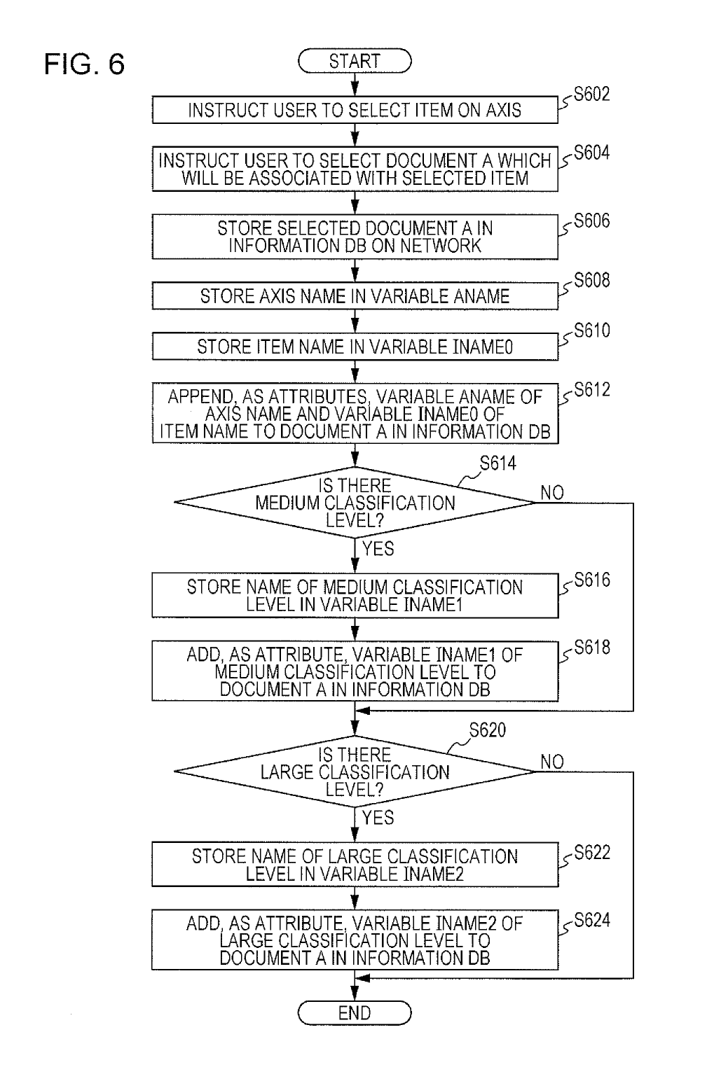

FIG. 6 is a flowchart illustrating an example (2) of registration processing according to the first exemplary embodiment. In this registration processing, information associated with an item is registered together with classification names in a hierarchical structure. More specifically, this processing is performed in a case in which items are formed in a hierarchical structure and item names in two or more predetermined levels are used.

In step S602, the registration item selecting module 115 instructs a user to select an item on an axis.

In step S604, the registration information selecting module 120 instructs the user to select a document A which will be associated with the item on the axis.

In step S606, the registration module 130 stores the selected document A in an information DB on a network.

In step S608, the attribute appending module 125 stores the name of the axis in a variable ANAME.

In step S610, the attribute appending module 125 stores the name of the item (or the name of an item in a small classification level) in a variable INAME0.

In step S612, the registration module 130 appends, as attributes, the variable ANAME corresponding to the axis name and the variable INAME0 corresponding to the item name to the document A stored in the information DB.

In step S614, the attribute appending module 125 determines whether there is a medium classification level. If the result of step S614 is YES, the process proceeds to step S616. If the result of step S614 is NO, the process proceeds to step S620.

In step S616, the attribute appending module 125 stores the name of the medium classification level in a variable INAME1.

In step S618, the registration module 130 adds, as an attribute, the variable INAME1 corresponding to the name of the medium classification level to the document A stored in the information DB.

In step S620, the attribute appending module 125 determines whether there is a large classification level. If the result of step S620 is YES, the process proceeds to step S622. If the result of step S620 is NO, the processing is terminated.

In step S622, the attribute appending module 125 stores the name of the large classification level in a variable INAME2.

In step S624, the registration module 130 adds, as an attribute, the variable INAME2 corresponding to the name of the large classification level to the document A stored in the information DB.

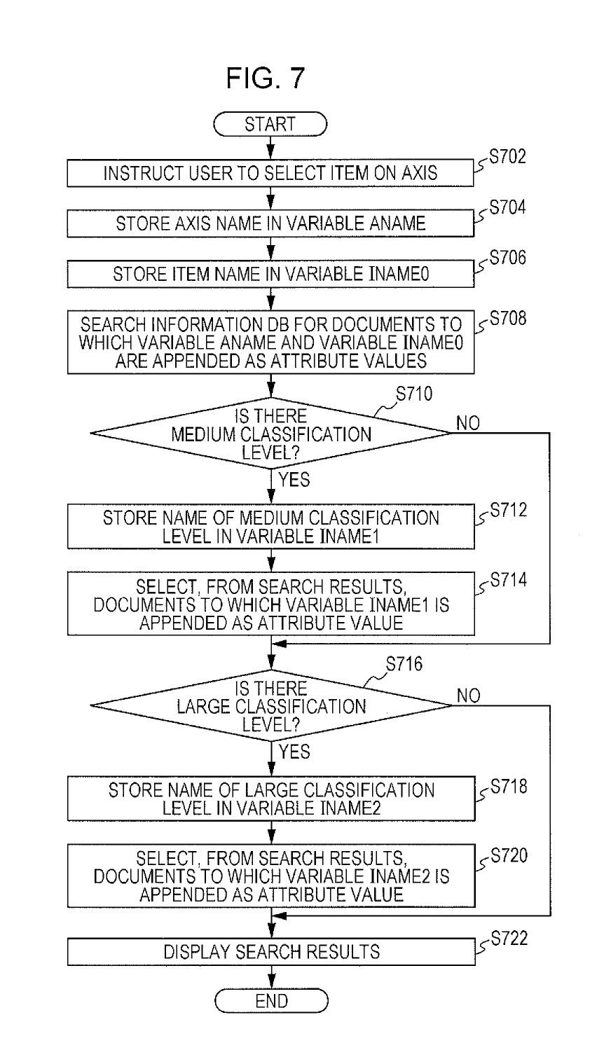

FIG. 7 is a flowchart illustrating an example (2) of search processing according to the first exemplary embodiment. In this search processing, information associated with an item is searched for together with classification names in a hierarchical structure.

In step S702, the search item selecting module 155 instructs a user to select an item on an axis.

In step S704, the search module 160 stores the name of the axis of the selected item in a variable ANAME.

In step S706, the search module 160 stores the name of the selected item (or the name of an item in a small classification level) in a variable INAME0.

In step S708, the search module 160 searches the information DB for documents to which the variable ANAME and the variable INAME0 are appended as attribute values.

In step S710, the search module 160 determines whether there is a medium classification level. If the result of step S710 is YES, the process proceeds to step S712. If the result of step S710 is NO, the process proceeds to step S716.

In step S712, the search module 160 stores the name of the medium classification level in a variable INAME1.

In step S714, the search module 160 selects, from search results, documents to which the variable INAME1 is appended as an attribute value.

In step S716, the search module 160 determines whether there is a large classification level. If the result of step S716 is YES, the process proceeds to step S718. If the result of step S716 is NO, the process proceeds to step S722.

In step S718, the search module 160 stores the name of the large classification level in a variable INAME2.

In step S720, the search module 160 selects, from the search results (search results obtained in step S708 or S714), documents to which the variable INAME2 is appended as an attribute value.

In step S722, the display module 165 displays search results.

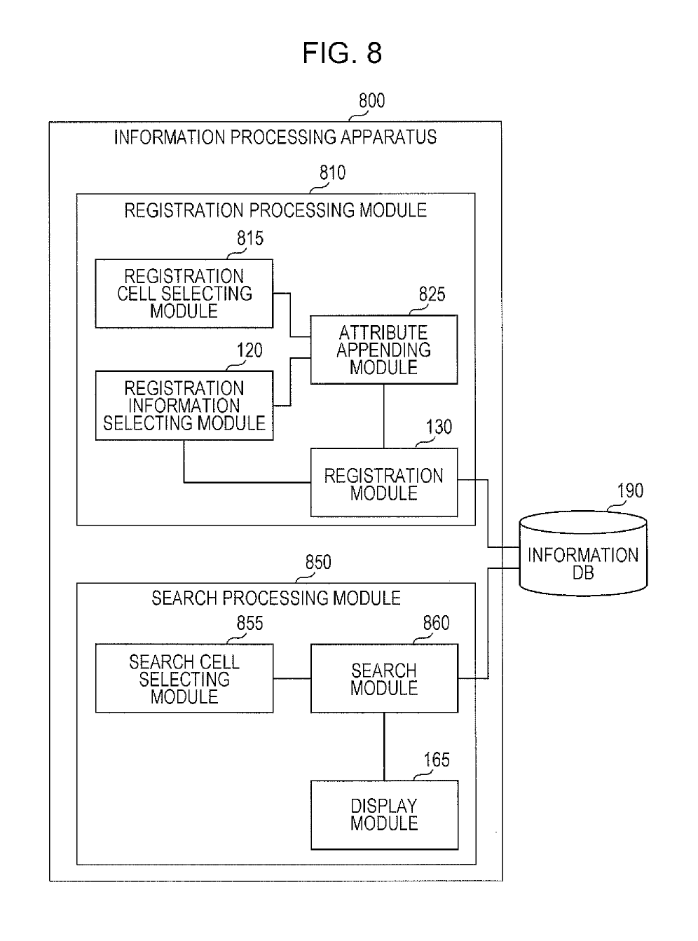

FIG. 8 is a block diagram illustrating conceptual modules forming an information processing apparatus 800 according to a first exemplary embodiment.

The information processing apparatus 800 is connected to an information DB 190. Elements similar to those of the first exemplary embodiment are designated by like reference numerals, and part of an explanation thereof will be omitted. The information processing apparatus 800 includes a registration processing module 810 and a search processing module 850.

The registration processing module 810 includes a registration cell selecting module 815, a registration information selecting module 120, an attribute appending module 825, and a registration module 130.

The registration cell selecting module 815 is connected to the attribute appending module 825. The registration cell selecting module 815 selects, through a selecting operation performed by a user, one of elements (cells) forming an array (matrix) within a QFD chart. The cells are square portions which are vertically and horizontally partitioned in a matrix. In a QFD chart used in the second exemplary embodiment, between two axes, a matrix into which cause-and-effect relationships between items may be input is deployed. In other words, such matrices are added to the QFD chart used in the first exemplary embodiment. In the second exemplary embodiment, processing is performed on cells within the first-axis/second-axis correlation matrix 315, the second-axis/third-axis correlation matrix 325, and the third-axis/fourth-axis correlation matrix 335 of the QFD chart 300 shown in FIG. 3. Cells are square portions within an item-correlation area 1710 shown in FIG. 17 into which symbols, such as triangles and double circles, are input.

The selection of an element within a QFD chart is performed as follows. A QFD chart is displayed on a display device, such as a display, and an operator selects a cell within the QFD chart by using a mouse, a touch panel, etc. The creation and display of a QFD chart will be discussed later with reference to FIGS. 11 through 16. The position of a cell is specified by items on two axes (a vertical axis and a horizontal axis). That is, a cell is disposed at a position at which an item on one axis and an item on the other axis intersect with each other.

The registration information selecting module 120 is connected to the attribute appending module 825 and the registration module 130.

The attribute appending module 825 is connected to the registration cell selecting module 815, the registration information selecting module 120, and the registration module 130. The attribute appending module 825 appends the name of a first axis corresponding to an element selected by the registration cell selecting module 815, the name of a first item within the first axis corresponding to the selected element, the name of a second axis corresponding to the selected element, and the name of a second item within the second axis corresponding to the selected element to information selected by the registration information selecting module 120. That is, there are four keys to be appended to information. More specifically, in two axes for specifying the position of a selected cell, (1) the name of one axis, (2) the name of an item within this axis, (3) the name of the other axis, and (4) the name of an item within the other axis are appended to information. If items corresponding to a selected cell are formed in a hierarchical structure, the names of items in one of the hierarchical levels may be used, or the names of items in two or more hierarchical levels may be used. More specifically, if a cell (within which a double circle is input) positioned on the third column from the left and the fourth row from the top of the item-correlation area 1710 shown in FIG. 17 is selected, (1) the name of one axis is “quality”, (2) the names of items within this axis are “safety/durability” and “durable”, (3) the name of the other axis is “performance”, and (4) the names of items within the other axis are “cooking container”, “basic performance”, and “not easily burned”.

The registration module 130 is connected to the registration information selecting module 120, the attribute appending module 825, and the information DB 190. The registration module 130 registers information to which the names of two axes and the names of two items are appended by the attribute appending module 825 in the information DB 190. With this registration processing, the registered information can be searched for by the search processing module 850.

The search processing module 850 includes a search cell selecting module 855, a search module 860, and a display module 165.

The search cell selecting module 855 is connected to the search module 860. The search cell selecting module 855 selects, through a selecting operation performed by a user, an element (cell) forming a matrix within a QFD chart. The selecting operation performed by the search cell selecting module 855 is similar to that performed by the registration cell selecting module 815. However, an element selected by the search cell selecting module 855 is used for searching for information related to the selected element.

The search module 860 is connected to the search cell selecting module 855, the display module 165, and the information DB 190. The search module 860 searches, on the basis of the name of a first axis corresponding to an element selected by the search cell selecting module 855, the name of a first item within the first axis corresponding to the selected element, the name of a second axis corresponding to the selected element, and the name of a second item within the second axis corresponding to the selected element, the information DB 190 for information to which the name of the first axis, the name of the first item, the name of the second axis, and the name of the second item are appended by the registration processing module 810. That is, the search module 860 searches the information DB 190 for information to which attributes that coincide with (1) the name of one axis, (2) the name of an item within this axis, (3) the name of the other axis, and (4) the name of an item within the other axis which specify an element selected by the search cell selecting module 855 are appended. If the items corresponding to the element selected by the search cell selecting module 855 are formed in a hierarchical structure, the search module 860 may search for information to which the names of items in the individual levels of a hierarchical structure that perfectly coincide with those of the items corresponding to the element selected by the search cell selecting module 855 are appended. Alternatively, the search module 860 may search for information to which the name of an item in any one of hierarchical levels that coincides with that of an item corresponding to the element selected by the search cell selecting module 855 is appended. A search may be conducted under the conditions that, not only the names of items, but also the levels of these items in a hierarchical structure, coincide with those of items corresponding to the element selected by the search cell selecting module 855.

The display module 165 is connected to the search module 860.

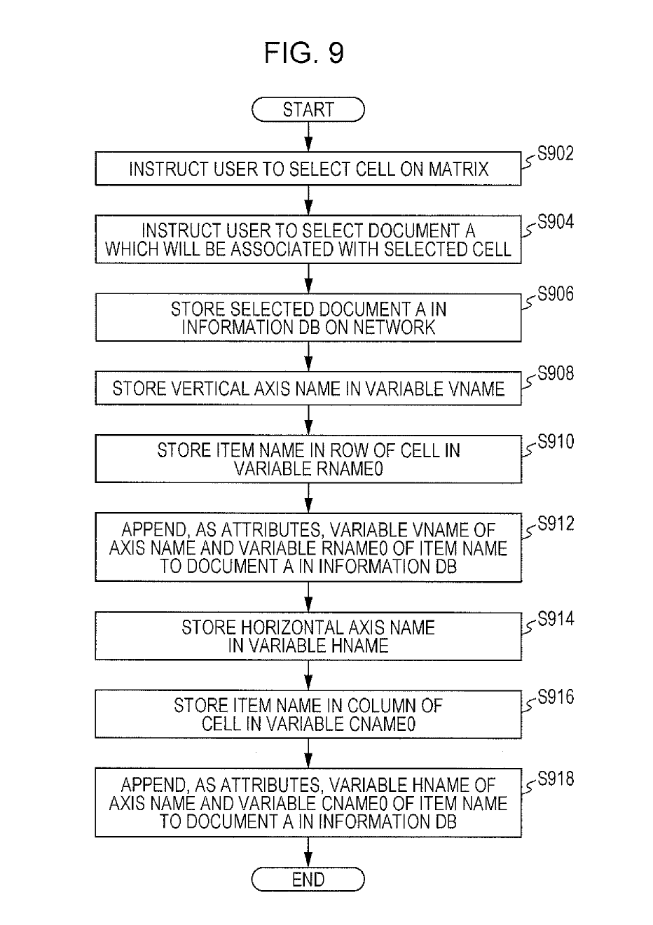

FIG. 9 is a flowchart illustrating an example of registration processing according to the second exemplary embodiment. In this registration processing, information associated with a cell is registered, but not together with a classification name in a hierarchical structure.

In step S902, the registration cell selecting module 815 instructs a user to select a cell on a matrix.

In step S904, the registration information selecting module 120 instructs the user to select a document A which will be associated with the cell selected by the user.

In step S906, the registration module 130 stores the selected document A in an information DB on a network.

In step S908, the attribute appending module 825 stores the name of an axis disposed in the vertical direction of the selected cell in a variable VNAME.

In step S910, the attribute appending module 825 stores the name of an item disposed in the row of the selected cell in a variable RNAME0.

In step S912, the registration module 130 appends, as attributes, the variable VNAME corresponding to the axis name and the variable RNAME0 corresponding to the item name to the document A stored in the information DB.

In step S914, the attribute appending module 825 stores the name of an axis disposed in the horizontal direction of the selected cell in a variable HNAME.

In step S916, the attribute appending module 825 stores the name of an item disposed in the column of the selected cell in a variable CNAME0.

In step S918, the registration module 130 appends, as attributes, the variable HNAME corresponding to the axis name and the variable CNAME0 corresponding to the item name to the document A stored in the information DB.

After step S918, steps S614 through S624 of the flowchart in FIG. 6 may be added. That is, if the items are formed in a hierarchical structure, the names of items in a two or more predetermined hierarchical levels may be used as attributes of the document A.

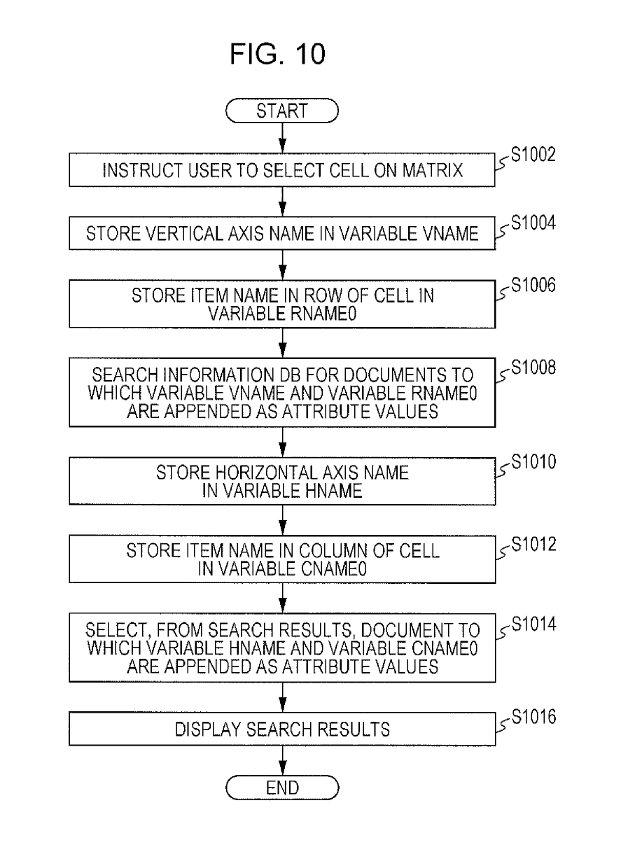

FIG. 10 is a flowchart illustrating an example of search processing according to the second exemplary embodiment. In this search processing, information associated with a cell is searched for, but not together with a classification name in a hierarchical structure.

In step S1002, the search cell selecting module 855 instructs a user to select a cell on a matrix.

In step S1004, the search module 860 stores the name of an axis disposed in the vertical direction of the selected cell in a variable VNAME.

In step S1006, the search module 860 stores the name of an item disposed in the row of the selected cell in a variable RNAME0.

In step S1008, the search module 860 searches the information DB for documents to which the variable VNAME and the variable RNAME0 are appended as attribute values.

In step S1010, the search module 860 stores the name of an axis disposed in the horizontal direction of the selected cell in a variable HNAME.

In step S1012, the search module 860 stores the name of an item in the column of the selected cell in a variable CNAME0.

In step S1014, the search module 860 selects, from search results obtained in step S1008, documents to which the variable HNAME and the variable CNAME0 are appended as attribute values.

In step S1016, the display module 165 displays search results.

After step S1016, steps S710 through S722 of the flowchart in FIG. 7 may be added. That is, if the items are formed in a hierarchical structure, and if the names of items in two or more predetermined hierarchical levels are registered in the information DB as attributes of the document A, such attributes may be used for selecting a document from search results.

FIG. 11 is a block diagram illustrating conceptual modules of an example of the configuration of a third exemplary embodiment. In the third exemplary embodiment, a QFD chart including an item or cell selected in the first or second exemplary embodiment is created and displayed.

An information processing apparatus 1100 of the third exemplary embodiment includes, as shown in FIG. 11, an axis-name setting module 1110, a parts (members)/system selecting module 1115 (hereinafter simply referred to as “parts/system selecting module 1115”), an axis-associated item forming module 1120, an inter-axis matching module 1125, a display module 1130, and an axis-related information storage module 1150.

The information processing apparatus 1100 is utilized for supporting design and development in order to improve the efficiency in developing technologies and products and also to enhance the qualities of technologies and products.

The parts/system selecting module 1115 is connected to the axis-name setting module 1110. The parts/system selecting module 1115 is used for selecting the type of QFD chart to be formed, and more specifically, the parts/system selecting module 1115 selects one of (1) a QFD chart for clarifying relationships between the manufacturing steps for parts and members and the quality of a product obtained by assembling these parts or members (hereinafter may also be referred to as a “parts/members QFD chart”) and (2) a QFD chart for clarifying relationships between the design conditions in developing a technology or a product and the quality of the technology or the product (hereinafter may also be referred to as a “system QFD chart”). The names of axes and items associated with the axes, which will be discussed later, will be different depending on which of the parts/members QFD chart and the system QFD chart is selected. In this case, an operator may select the type of QFD chart by performing a selecting operation. Alternatively, the type of QFD chart may be selected according to an operator, or the department or the job type of an operator. For example, a table in which operator identifiers for uniquely identifying operators in this exemplary embodiment are individually associated with the parts/members QFD chart or the system QFD chart may be prepared and stored in the axis-related information storage module 1150, and by using this table, the type of QFD chart may be selected from an operator identifier. Alternatively, a table in which operators are individually associated with departments or job types, and a table in which departments or job types are individually associated with the parts/members QFD chart or the system QFD chart may be prepared and stored in the axis-related information storage module 1150. By using these two tables, the QFD chart may be selected from an operator identifier for uniquely identifying an associated operator.

The axis-name setting module 1110 is connected to the parts/system selecting module 1115, the axis-associated item forming module 1120, and the axis-related information storage module 1150. The axis-name setting module 1110 sets names of first through fourth axes. In this case, the concept of setting of the names of axes includes generating of the names of axes. The axis-name setting module 1110 may set the names of the first through fourth axes on the basis of a selection result of the parts/system selecting module 1115. That is, if the parts/members QFD chart has been selected by the parts/system selecting module 1115, the axis-name setting module 1110 may set “quality” as the name of the first axis, “performance” as the name of the second axis, “structures and physical properties” as the name of the third axis, and “production conditions” as the name of the fourth axis. If the system QFD chart has been selected by the parts/system selecting module 1115, the axis-name setting module 1110 may set “quality” as the name of the first axis, “mechanism” as the name of the second axis, “physical characteristics” as the name of the third axis, and “design conditions” as the name of the fourth axis.

The axis-associated item forming module 1120 is connected to the axis-name setting module 1110, the inter-axis matching module 1125, the display module 1130, and the axis-related information storage module 1150. The axis-associated item forming module 1120 forms, through a selecting operation performed by an operator, items associated with axes for which names are set by the axis-name setting module 1110. The axis-associated item forming module 1120 forms (1) items indicating quality requirements of a product, as items associated with the first axis, (2) items indicating performance capabilities provided by the individual parts and members in order to satisfy the quality requirements of the product, as items associated with the second axis, (3) items concerning the structures and the physical properties of the individual parts and members, as items associated with the third axis, and (4) items which define production conditions for the individual parts and members, as items associated with the fourth axis.

Particularly when the parts/members QFD chart is selected by the parts/system selecting module 1115, the axis-associated item forming module 1120 may form, through a selecting operation performed by an operator, (1) items indicating quality requirements of a product, as items associated with the first axis, (2) items indicating performance capabilities provided by the individual parts and members in order to satisfy the product quality requirements, as items associated with the second axis, (3) items concerning the structures and the physical properties of the individual parts and members, as items associated with the third axis, and (4) items which define design conditions for the individual parts and members, as items associated with the fourth axis.

Alternatively, particularly when the system QFD chart is selected by the parts/system selecting module 1115, the axis-associated item forming module 1120 may form, through a selecting operation performed by an operator, (1) items indicating quality requirements of a product, as items associated with the first axis, (2) items concerning a physical mechanism whose behavior is determined by items of physical characteristics and which dominates the quality of the product, as items associated with the second axis, (3) items indicating system physical characteristics determined by design conditions, as items associated with the third axis, and (4) items indicating design conditions, as items associated with the fourth axis. Additionally, as items associated with each of the first through fourth axes, in addition to the individual parts and members, “all parts/members” (large classification of items) indicating items applicable to all the parts/members may be included.

The axis-associated item forming module 1120 may cause the inter-axis matching module 1125 to determine consistencies of the items formed by the axis-associated item forming module 1120 between different axes.

There may be certain items which are difficult to classify into an exact item in each axis, for example, items applicable to all the parts/members, system parameters, and external disturbance. The axis-associated item forming module 1120 may form such items such that they are deployed in parallel with the items of the associated axes.

Items associated with the axes may have a hierarchical structure having at least one level, such as an axis item table 1300 shown in FIG. 13. FIG. 13 shows an example of the data structure of the axis item table 1300. The axis item table 1300 includes an axis name column 1310 and an item name column 1320. In the axis name column 1310 stores therein names of axes. The item name column 1320 stores therein item names associated with the axes. The items have a hierarchical structure having, for example, three levels, such as large, medium, and small classifications. The item name column 1320 includes a large classification column 1322, a medium classification column 1324, and a small classification column 1326. The large classification column 1322 stores therein, as the first level, items classified under the large classification. The medium classification column 1324 stores therein, as the second level, items classified under the medium classification. The small classification column 1326 stores therein, as the third level, items classified under the small classification. The hierarchical structure may have only one level having a small classification, two levels having large and small classifications, and three levels having large, medium, and small classifications.

The inter-axis matching module 1125 is connected to the axis-associated item forming module 1120. The inter-axis matching module 1125 determines whether there is a consistency of items of a predetermined hierarchical level at least between the first and second axes, the second and third axes, and the third and fourth axes. If the inter-axis matching module 1125 determines that there is no consistency of items, it may correct a corresponding item. In this case, corrections may be made automatically or in accordance with an operation of an operator (for example, correction patterns are shown and an operator is instructed to select one of the correction patterns, or a warning is issued and an operator is instructed to correct an item).

The display module 1130 is connected to the axis-associated item forming module 1120. On the basis of the names of the axes set by the axis-name setting module 1110 and the items formed by the axis-associated item forming module 1120, the display module 1130 displays a QFD chart used for developing a product, in which the names of the first through fourth axes are deployed within a region divided into top, bottom, right and left sections from the center of the QFD chart, the items associated with the first through fourth axes are deployed in the directions extending upward, downward, rightward, and leftward from the center, and matrices into which cause-and-effect relationships between associated items may be input are deployed at least between the first and second axes, the second and third axes, and the third and fourth axes. The QFD chart displayed by the display module 1130 may be a parts/members QFD chart, such as that shown in FIG. 17, or a system QFD chart, such as that shown in FIG. 18, which will be discussed later.

The axis-related information storage module 1150 is connected to the axis-name setting module 1110 and the axis-associated item forming module 1120. The axis-related information storage module 1150 stores therein information related to axes, for example, the axis item table 1300 shown in FIG. 13.

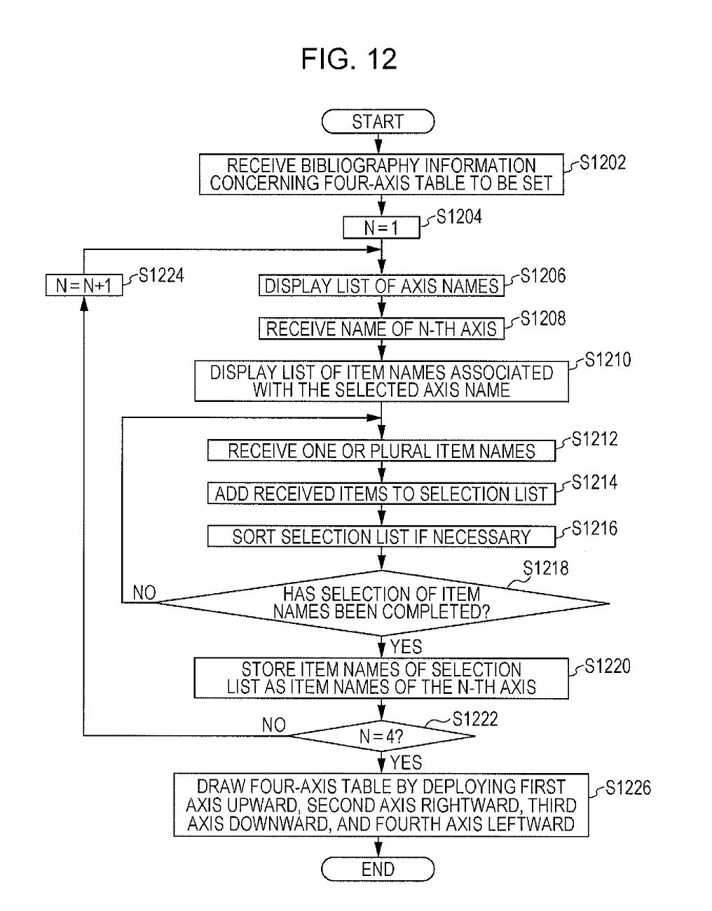

FIG. 12 is a flowchart illustrating an example of processing according to the third exemplary embodiment.

In step S1202, the axis-name setting module 1110 receives bibliography information concerning a four-axis table to be set. Examples of the bibliography information are an operator name, an operator identifier, the date and time at which a table is created, and a product name.

In step S1204, the axis-name setting module 1110 sets a variable N to be 1 (N=1). The variable N is a value indicating an axis number.

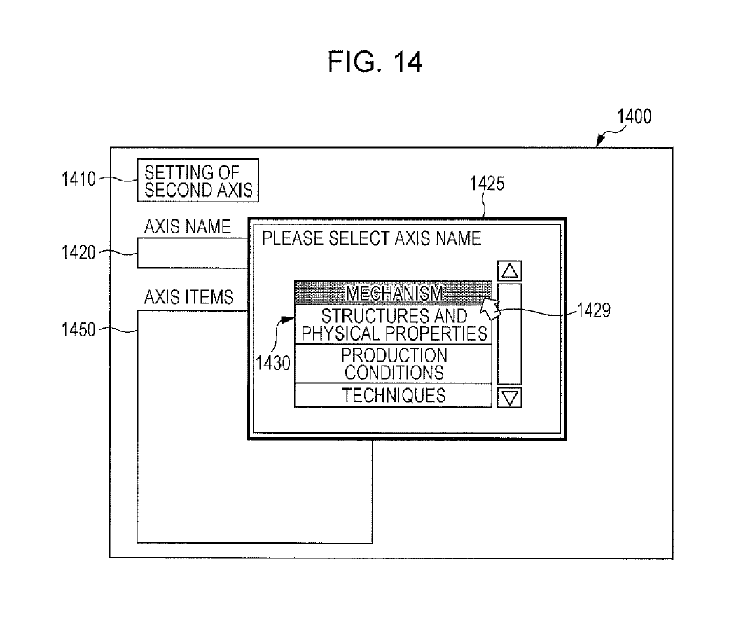

In step S1206, the axis-name setting module 1110 displays a list of axis names. FIG. 14 shows an example of processing for displaying and selecting axis names. On a setting screen 1400, such as a liquid crystal display, provided in the information processing apparatus 1100, an N-th axis setting column 1410, an axis-name setting column 1420, and an axis-item setting column 1450 are displayed. The N-th axis setting column 1410 displays a currently selected axis, i.e., an N-th axis, in accordance with the value of the variable N set in step S1204 or S1224. When an operator selects the axis-name setting column 1420 by performing a selecting operation, an axis-name selecting area 1425 including an axis-name list display area 1430 is displayed. Then, the operator is instructed to select one of the axis names displayed in the axis-name list display area 1430 by using a cursor 1429. The axis names within the axis-name list display area 1430 may be extracted from the axis name column 1310 of the axis item table 1300.

In step S1208, the axis-name setting module 1110 receives a name of the N-th axis.

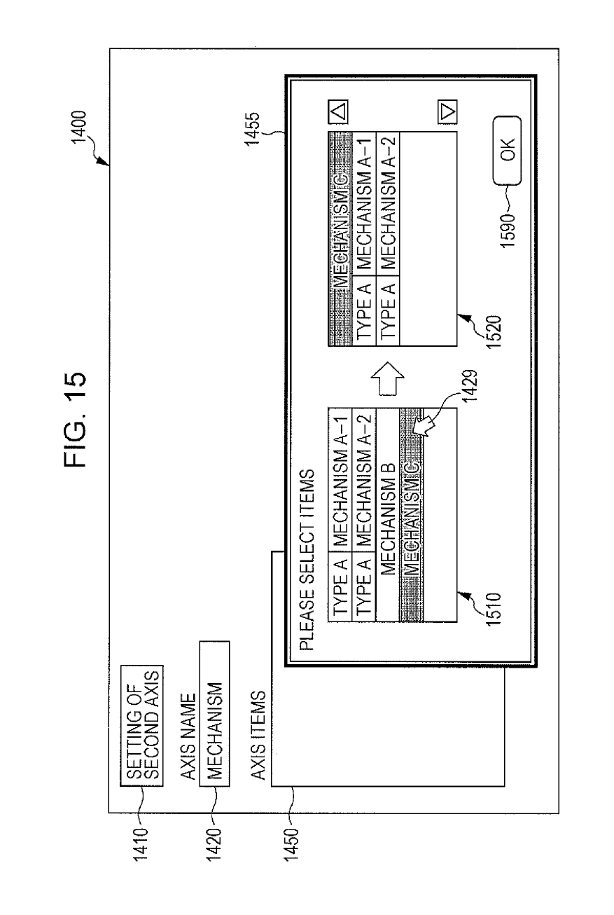

In step S1210, the axis-associated item forming module 1120 displays a list of item names associated with the selected axis name. FIG. 15 shows an example of processing for displaying and selecting axis items. On the setting screen 1400, the N-th axis setting column 1410, the axis-name setting column 1420, and the axis-item setting column 1450 are displayed. When the operator selects the axis-item setting column 1450 by performing a selecting operation, an item selecting area 1455 including an item selecting table 1510 and a selection-result display table 1520 is displayed. When the operator selects an item within the item selecting table 1510 by using the cursor 1429, the selected item is moved to the selection-result display table 1520 and is displayed. The item names within the item selecting table 1510 may be extracted from the item name column 1320 of the axis item table 1300.

In step S1212, the axis-associated item forming module 1120 receives one or plural item names.

In step S1214, the axis-associated item forming module 1120 adds the received items to a selection list.

In step S1216, if necessary, the axis-associated item forming module 1120 sorts the selection list. For example, items in the selection list may be sorted in accordance with the order of items of an axis for which items have already been selected.

In step S1218, the axis-associated item forming module 1120 determines whether the selection of item names has been completed. If the result of step S1218 is YES, the process proceeds to step S1220. If the result of step S1218 is NO, the process returns to step S1212. For example, if an OK button 1590 displayed within the item selecting area 1455 shown in FIG. 15 is operated by the operator, the axis-associated item forming module 1120 determines that the selection of item names has been completed.

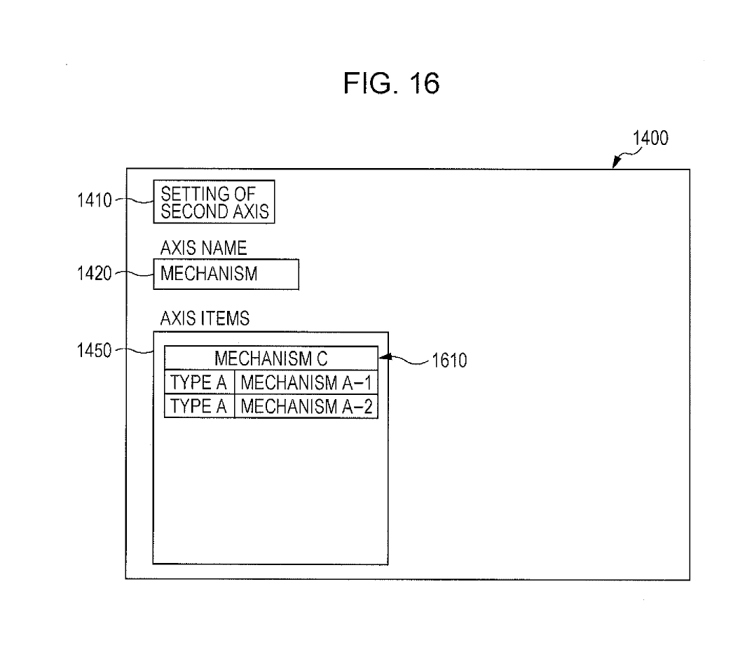

In step S1220, the axis-associated item forming module 1120 stores the item names of the selection list in the axis-related information storage module 1150 as the item names of the N-th axis. FIG. 16 shows a display example of the selected axis name and the selected items. A currently selected axis is displayed in the N-th axis setting column 1410, the name of the axis is displayed in the axis-name setting column 1420, and an axis/item setting result table 1610 is displayed in the axis-item setting column 1450. A combination of the N-th axis setting column 1410, the axis-name setting column 1420, and the axis/item setting result table 1610 is stored in the axis-related information storage module 1150.

In step S1222, the axis-associated item forming module 1120 determines whether N is four. If the result of step S1222 is YES, the process proceeds to step S1226. If the result of step S1222 is NO, the process proceeds to step S1224.

In step S1224, the axis-name setting module 1110 increments N by one (N=N+1).

In this example of processing, the first through fourth axes are sequentially received. However, the operator may select, as desired, axis numbers to which axis names and items associated with the axes are to be appended.

In step S1226, the display module 1130 draws a four-axis table by deploying the first axis upward, the second axis rightward, the third axis downward, and the fourth axis leftward.

For example, the four-axis table may be displayed as the parts/members QFD chart shown in FIG. 17 or the system QFD chart shown in FIG. 18.

In the example shown in FIG. 17, four axes (a quality axis (first axis) 1700, a performance axis (second axis) 1720, a structures/physical-properties axis (third axis) 1740, and a production-conditions axis (fourth axis) 1760) are shown. The names of the individual axes are displayed in end triangular portions of the four axes 1700, 1720, 1740, and 1760, which are an axis-name display area (quality) 1702, an axis-name display area (performance) 1722, an axis-name display area (structures and physical properties) 1742, and an axis-name display area (production conditions) 1762. Items associated with the quality axis (first axis) 1700 are displayed in an item-name display area 1704 extending upward from the axis-name display area 1702. Items associated with the performance axis (second axis) 1720 are displayed in an item-name display area 1724 extending rightward from the axis-name display area 1722. Items associated with the structures/physical-properties axis (third axis) 1740 are displayed in an item-name display area 1744 extending downward from the axis-name display area 1742. Items associated with the production-conditions axis (fourth axis) 1760 are displayed in an item-name display area 1764 extending leftward from the axis-name display area 1762. Then, at least in three areas, that is, in an item-correlation area 1710 between the item-name display areas 1704 and 1724, in an item-correlation area 1730 between the item-name display areas 1724 and 1744, and in an item-correlation area 1750 between the item-name display areas 1744 and 1764, matrices are generated. In these matrices, for example, in a matrix generated in the item-correlation area 1710, at a position at which two associated items displayed in the item-name display areas 1704 and 1724 intersect with each other, a cause-and-effect relationship between these two items may be input. For example, at a position between an item “does not burn you” of “safety/durability” in the item-name display area 1704 and an item “stay cool” of “basic performance” of “handle” in the item-name display area 1724, a symbol ⊙ indicating a strong correlation is input. The correlation between two associated items may be represented by a numeric value, a color, or a combination thereof. For example, if a positive correlation is indicated by a red symbol and a negative correlation is indicated by a blue symbol, signs (+ and −) of a correlation may also be indicated, in addition to the strength of a correlation. In an item-correlation area 1770 between the item-name display areas 1704 and 1764, a matrix into which cause-and-effect relationships between items in the item-correlation areas 1704 and 1764 may be input may be generated. In this parts/members QFD chart, influences of “production conditions” on “quality” can be examined from the relationships between “production conditions” and “structures and physical properties”, the relationships between “structures and physical properties” and “performance”, and between “performance” and “quality”. That is, the information processing apparatus 1100 of the third exemplary embodiment makes it easier to clarify a mechanism for obtaining a certain result, i.e., “quality” (phenomenon), from “production conditions” through “structures and physical properties” and “performance”, than the use of information processing apparatuses other than the third exemplary embodiment. For example, it is possible to understand in advance the fact that certain measures to improve the quality of one factor may decrease the quality of another factor and the reason for this fact. Then, if a development technical problem occurs, it is possible to extract an analytic technique for examining reasons or measures for this problem, and also to obtain such an analytic technique in advance.

For example, in order to fill in the matrix concerning the second axis, it is necessary to understand the mechanism of functions of individual parts and members. By checking for portions of the matrix into which an operator is unable to input a symbol, a numeric value, etc., indicating a relationship between items, necessary analytic techniques can be extracted.

Generally, the factors indicated in the individual axes are handled by different departments, and thus, collaboration between different departments can be promoted. As shown in FIGS. 14 and 15, when axis names and item names are selected from prepared lists, the same terms are used in any multi-axis tables. Thus, the third exemplary embodiment is particularly effective.

The example shown in FIG. 18 is similar to that shown in FIG. 17. However, since the example shown in FIG. 18 concerns a system QFD chart, it has an item “all parts/members” in addition to items concerning individual parts and members, as stated above. By using this system QFD chart, influences of “design conditions” on “quality” can be examined from the relationships between “design conditions” and “physical characteristics”, the relationships between “physical characteristics” and “mechanism”, and the relationships between “mechanism” and “quality”. That is, the information processing apparatus 1100 of the third exemplary embodiment makes it easier to clarify a mechanism for obtaining a certain result, i.e., “quality” (phenomenon), from “design conditions” through “physical characteristics” and “mechanism”, than the use of information processing apparatuses other than the third exemplary embodiment. For example, it is possible to understand in advance the fact that certain measures to improve the quality of one factor may decrease the quality of another factor and the reason for this fact. Then, if a development technical problem occurs, it is possible to extract an analytic technique for examining reasons or measures for this problem, and also to obtain such an analytic technique in advance.

For example, in order to fill in the matrix concerning the second axis, it is necessary to understand a physical mechanism in which characteristics determined by design conditions influence the quality. By checking for portions of the matrix into which an operator is unable to input a symbol, a numeric value, etc., indicating a relationship between items, necessary analytic techniques can be extracted.

After an operator has input symbols, numeric values, etc. indicating correlations between items, if there are some portions of matrices into which symbols, numeric values, etc. are not input, the display module 1130 may display information that there are some items for which correlations are not indicated. For example, such portions of the matrices may be displayed in a color different from the color of the other portions of the matrices in which correlations are indicated.

Additionally, items of a matrix concerning the third axis into which correlations are not indicated may be extracted, and the display module 1130 may indicate that such items are included as items of “structures/physical-properties” in association with “performance” but correlations are not indicated because of an insufficient measurement technique.

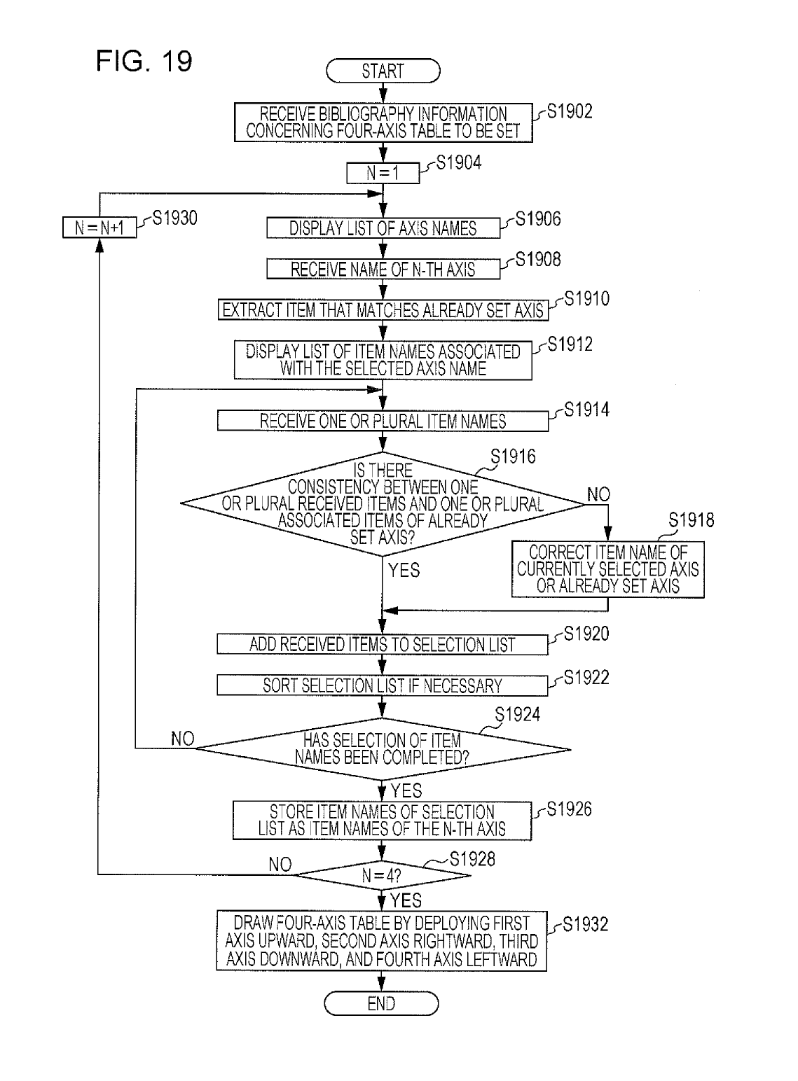

FIG. 19 is a flowchart illustrating another example of processing according to the third exemplary embodiment. In this flowchart, steps S1910, S1916, and S1918 are added to the steps of the flowchart in FIG. 12. Details of steps S1910, S1916, and S1918 will be given. The other steps are similar to those in FIG. 12.

In step S1902, the axis-name setting module 1110 receives bibliography information concerning a four-axis table to be set.

In step S1904, the axis-name setting module 1110 sets a variable N to be 1 (N=1).

In step S1906, the axis-name setting module 1110 displays a list of axis names.

In step S1908, the axis-name setting module 1110 receives a name of the N-th axis.

In step S1910, an item that matches a certain item of an axis for which items have already been set is extracted. The axis-associated item forming module 1120 causes the inter-axis matching module 1125 to perform this processing. For example, an item that matches the item classified under the large classification of the hierarchical structure of an already set axis is extracted. As the axis for which items have already been set (hereinafter simply referred to as an “already set axis”), an axis which forms a matrix together with a currently selected axis may be used. For example, if the currently selected axis is the second axis, the already set axis is the first axis. If the currently selected axis is the third axis, the already set axis is the second axis. If the currently selected axis is the fourth axis, the already set axis is the third axis.

In step S1912, the axis-associated item forming module 1120 displays a list of item names associated with the selected axis name. In this case, only the items extracted in step S1910 may be displayed. Alternatively, items other than the items extracted in step S1910 may also be included, in which case, the items extracted in step S1910 may be displayed in a mode (shape, pattern, color, or a combination thereof) different from that of the other items.

In step S1914, the axis-associated item forming module 1120 receives one or plural item names.

In step S1916, the inter-axis matching module 1125 determines whether there is a consistency between one or plural items selected in step S1914 and one or plural associated items of the already set axis. If the result of step S1916 is YES, the process proceeds to step S1920. If the result of step S1916 is NO, the process proceeds to step S1918. In this case, “having a consistency” means that items are formed in a hierarchical structure and the name of the item associated with the currently selected axis classified under a predetermined level of the hierarchical structure is the same as that associated with the already set axis. The already set axis may be an axis which forms a matrix with a currently selected axis, as stated above. If there is an item that does not match a certain item of the already set axis, the process proceeds to step S1918.

In step S1918, the axis-associated item forming module 1120 corrects the name of the item of the currently selected axis or the already set axis. In this case, the operator is allowed to correct the name of the item of the currently selected axis or the already set axis. However, the operator does not necessarily have to make correction.

In step S1920, the axis-associated item forming module 1120 adds the received items to a selection list.

In step S1922, if necessary, the axis-associated item forming module 1120 sorts the selection list.

In step S1924, the axis-associated item forming module 1120 determines whether the selection of item names has been completed. If the result of step S1924 is YES, the process proceeds to step S1926. If the result of step S1924 is NO, the process returns to step S1914.

In step S1926, the axis-associated item forming module 1120 stores the item names of the selection list in the axis-related information storage module 1150 as the item names of the N-th axis.

In step S1928, the axis-associated item forming module 1120 determines whether N is four. If the result of step S1928 is YES, the process proceeds to step S1932. If the result of step S1928 is NO, the process proceeds to step S1930.

In step S1930, the axis-name setting module 1110 increments N by one (N=N+1).

In step S1932, the display module 1130 draws a four-axis table by deploying the first axis upward, the second axis rightward, the third axis downward, and the fourth axis leftward.

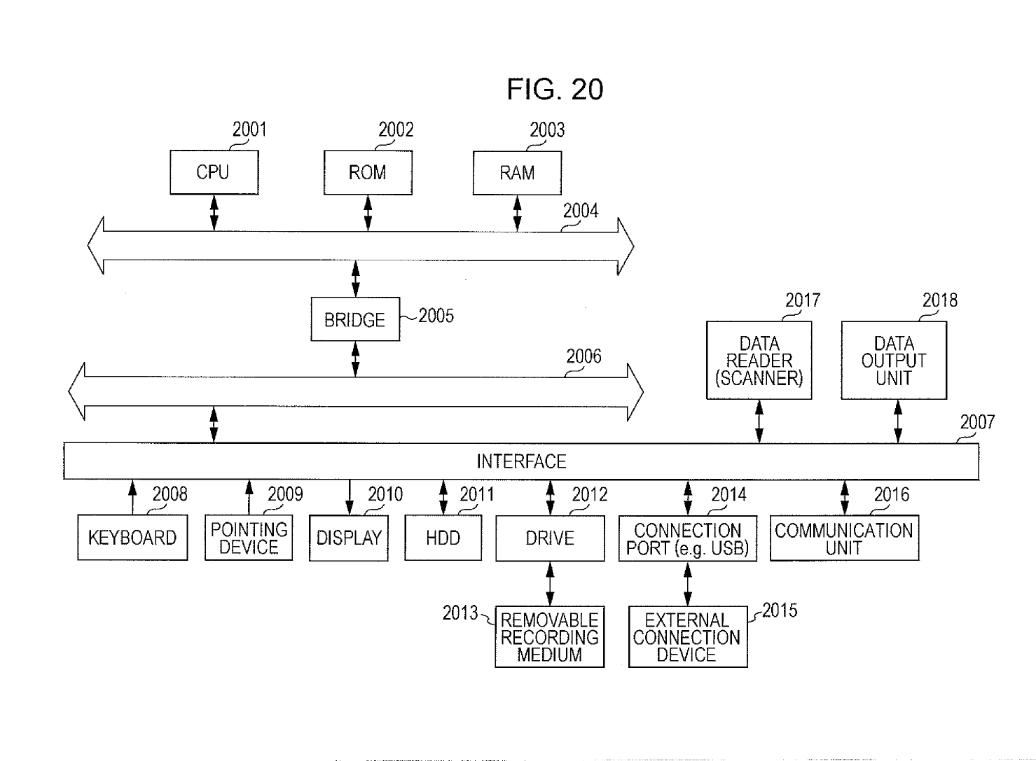

An example of the hardware configuration of the information processing apparatuses 100, 800, and 1100 of the first, second, and third exemplary embodiments will be described below with reference to FIG. 20. The configuration shown in FIG. 20 is an example of the hardware configuration of, for example, a personal computer (PC), including a data reader 2017, such as a scanner, and a data output unit 2018, such as a printer.

A central processing unit (CPU) 2001 is a controller that executes processing in accordance with a computer program which describes an execution sequence of modules discussed in the above-described first through third exemplary embodiments, such as the registration item selecting module 115, the registration information selecting module 120, the attribute appending module 125, the registration module 130, the search item selecting module 155, the search module 160, the display module 165, the registration cell selecting module 815, the search cell selecting module 855, the axis-name setting module 1110, the parts/system selecting module 1115, the axis-associated item forming module 1120, the inter-axis matching module 1125, and the display module 1130.

A read only memory (ROM) 2002 stores therein programs and operation parameters used by the CPU 2001. A random access memory (RAM) 2003 stores therein a program used during the execution of the CPU 2001 and parameters which vary appropriately during the execution of the CPU 2001. The CPU 2001, the ROM 2002, and the RAM 2003 are connected to one another via a host bus 2004, such as a CPU bus.

The host bus 2004 is connected to an external bus 2006, such as a Peripheral Component Interconnect/Interface (PCI) bus, via a bridge 2005.

A keyboard 2008 and a pointing device 2009, such as a mouse, are input devices operated by an operator. A display 2010, such as a liquid crystal display device or a cathode ray tube (CRT), displays various items of information as text or image information.

A hard disk drive (HDD) 2011 contains a hard disk and drives the hard disk to record or play back information or a program executed by the CPU 2001. In the hard disk, the axis item table 1300, set axis names, set item names, etc. are stored. Various other computer programs, such as various data processing programs, are also stored in the hard disk.

A drive 2012 reads data or a program recorded on a removable recording medium 2013 set in the drive 2012, such as a magnetic disk, an optical disc, a magneto-optical disk, or a semiconductor memory, and supplies the read data or program to the RAM 2003 connected to the drive 2012 via an interface 2007, the external bus 2006, the bridge 2005, and the host bus 2004. The removable recording medium 2013 is also usable as a data recording region, which is similar to a hard disk.

A connection port 2014 is a port used for connecting an external connection device 2015 to the PC, and has a connecting portion, such as a Universal. Serial Bus (USB) port or an IEEE1394 port. The connection port 2014 is connected to, for example, the CPU 2001, via the interface 2007, the external bus 2006, the bridge 2005, and the host bus 2004. A communication unit 2016 is connected to a communication line and executes data communication processing with external sources. The data reader 2017 is, for example, a scanner, and executes processing for reading documents. The data output unit 2018 is, for example, a printer, and executes processing for outputting document data.

The hardware configuration of the information processing apparatus 100, 800, or 1100 shown in FIG. 20 is only an example, and the exemplary embodiments may be configured in any manner as long as the modules described in the exemplary embodiments are executable. For example, some modules may be configured as dedicated hardware (e.g., an application specific integrated circuit (ASIC)), or some modules may be installed in an external system and be connected to the PC via a communication line. Alternatively, a system, such as that shown in FIG. 20, may be connected to a system, such as that shown in FIG. 20, via a communication line, and may be operated in cooperation with each other.

The above-described program may be stored in a recording medium and be provided. The program recorded on a recording medium may be provided via a communication medium. In this case, the above-described program may be implemented as a “non-transitory computer readable medium storing the program therein” in an exemplary embodiment of the invention.

The “non-transitory computer readable medium storing a program therein” is a recording medium storing a program therein that can be read by a computer, and is used for installing, executing, and distributing the program. Examples of the recording medium are digital versatile disks (DVDs), and more specifically, DVDs standardized by the DVD Forum, such as DVD-R, DVD-RW, and DVD-RAM, DVDs standardized by the DVD+RW Alliance, such as DVD+R and DVD+RW, compact discs (CDs), and more specifically, a read only memory (CD-ROM), a CD recordable (CD-R), and a CD rewritable (CD-RW), Blu-ray disc (registered), a magneto-optical disk (MO), a flexible disk (FD), magnetic tape, a hard disk, a ROM, an electrically erasable programmable read only memory (EEPROM) (registered), a flash memory, a RAM, a secure digital (SD) memory card, etc.

The entirety or part of the above-described program may be recorded on such a recording medium and stored therein or distributed. Alternatively, the entirety or part of the program may be transmitted through communication by using a transmission medium, such as a wired network used for a local area network (LAN), a metropolitan area network (MAN), a wide area network (WAN), the Internet, an intranet, or an extranet, a wireless communication network, or a combination of such networks. The program may be transmitted by using carrier waves.

The above-described program may be part of another program, or may be recorded, together with another program, on a recording medium. The program may be divided and recorded on plural recording media. Further, the program may be recorded in any form, e.g., it may be compressed or encrypted, as long as it can be reconstructed.

The third exemplary embodiment discussed with reference to FIGS. 11 through 19 may be implemented as follows. The first or second exemplary embodiment may be combined with the third exemplary embodiment.

(A1) An information processing apparatus comprising:

an axis-name setting unit that sets names of first through fourth axes;

an item forming unit that forms an item associated with an axis for which a name is set by the axis-name setting unit; and

a display that displays, on the basis of the names of the first through fourth axes set by the axis-name setting unit and the items formed by the item forming unit, a quality function deployment chart used for developing a product, in which the names of the first through fourth axes are deployed in a region divided into top, bottom, right, and left sections from a center of the quality function deployment chart, the items associated with the first through fourth axes are deployed in directions extending upward, downward, rightward, and leftward from the center, and matrices into which relationships between items are input are deployed at least between the first axis and the second axis, between the second axis and the third axis, and between the third axis and the fourth axis,

wherein the item forming unit forms items associated with the first through fourth axes as a result of an operator selecting an item indicating a quality requirement of the product as an item associated with the first axis, an item indicating a performance capability necessary for satisfying a quality requirement of the product by each of parts and members of the product as an item associated with the second axis, an item concerning a structure and a physical property of each of the parts and the members of the product as an item associated with the third axis, and an item which defines a production condition for each of the parts and the members of the product as an item associated with the fourth axis.

(A2) An information processing apparatus comprising:

an axis-name setting unit that sets names of first through fourth axes;

an item forming unit that forms an item associated with an axis for which a name is set by the axis-name setting unit; and

a display that displays, on the basis of the names of the first through fourth axes set by the axis-name setting unit and the items formed by the item forming unit, a quality function deployment chart used for developing a product, in which the names of the first through fourth axes are deployed in a region divided into top, bottom, right, and left sections from a center of the quality function deployment chart, the items associated with the first through fourth axes are deployed in directions extending upward, downward, rightward, and leftward from the center, and matrices into which relationships between items are input are deployed at least between the first axis and the second axis, between the second axis and the third axis, and between the third axis and the fourth axis,

wherein the item forming unit forms items associated with the first through fourth axes as a result of an operator selecting an item indicating a quality requirement of the product as an item associated with the first axis, an item concerning a physical mechanism which dominates a quality of the product, the behavior of the physical mechanism being determined by an item of a physical characteristic, as an item associated with the second axis, an item indicating a system physical characteristic determined by a design condition as an item associated with the third axis, and an item indicating a design condition as an item associated with the fourth axis.

(A3) The information processing apparatus according to (A1) or (A2), wherein the axis-name setting unit displays an axis name list for the operator, and sets names selected from the axis name list by the operator as the names of the axes.

(A4) The information processing apparatus according to one of (A1) to (A3), wherein the item forming unit displays an item list for the operator, and sets items selected from the item list by the operator as the items associated with the axes.

(A5) The information processing apparatus according to one of (A1) to (A4), wherein:

the items associated with the axes have a hierarchical structure; and

the item forming unit determines whether there is a consistency of items in a predetermined level of the hierarchical structure at least between the first axis and the second axis, between the second axis and the third axis, and between the third axis and the fourth axis, and if it is determined that there is no consistency of items in the predetermined level of the hierarchical structure, the item forming unit corrects an item of one axis which is not consistent with an associated item of an associated axis to be compared.

(A6) A non-transitory computer readable medium storing a program causing a computer to execute a process, the process comprising:

setting names of first through fourth axes;

forming an item associated with an axis for which a name is set; and

displaying, on the basis of the set names of the first through fourth axes and the formed items, a quality function deployment chart used for developing a product, in which the names of the first through fourth axes are deployed in a region divided into top, bottom, right, and left sections from a center of the quality function deployment chart, the items associated with the first through fourth axes are deployed in directions extending upward, downward, rightward, and leftward from the center, and matrices into which relationships between items are input are deployed at least between the first axis and the second axis, between the second axis and the third axis, and between the third axis and the fourth axis,

wherein items associated with the first through fourth axes are formed as a result of an operator selecting an item indicating a quality requirement of the product as an item associated with the first axis, an item indicating a performance capability necessary for satisfying a quality requirement of the product by each of parts and members of the product as an item associated with the second axis, an item concerning a structure and a physical property of each of the parts and the members of the product as an item associated with the third axis, and an item which defines a production condition for each of the parts and the members of the product as an item associated with the fourth axis.

(A7) A non-transitory computer readable medium storing a program causing a computer to execute a process, the process comprising:

setting names of first through fourth axes;

forming an item associated with an axis for which a name is set; and

displaying, on the basis of the set names of the first through fourth axes and the formed items, a quality function deployment chart used for developing a product, in which the names of the first through fourth axes are deployed in a region divided into top, bottom, right, and left sections from a center of the quality function deployment chart, the items associated with the first through fourth axes are deployed in directions extending upward, downward, rightward, and leftward from the center, and matrices into which relationships between items are input are deployed at least between the first axis and the second axis, between the second axis and the third axis, and between the third axis and the fourth axis,

wherein items associated with the first through fourth axes are formed as a result of an operator selecting an item indicating a quality requirement of the product as an item associated with the first axis, an item concerning a physical mechanism which dominates a quality of the product, the behavior of the physical mechanism being determined by an item of a physical characteristic, as an item associated with the second axis, an item indicating a system physical characteristic determined by a design condition as an item associated with the third axis, and an item indicating a design condition as an item associated with the fourth axis.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first selector that selects, through a selecting operation performed by an operator, an item disposed within a quality function deployment chart, the quality function deployment chart having at least three axes, an item being associated with each of the axes, a name being appended to each of the axes, and a name being appended to each of the items;
a second selector that selects, through a selecting operation performed by the operator, information related to the item selected by the first selector; and
an appending unit that appends a name of an axis corresponding to the item selected by the first selector and a name of the item to the information selected by the second selector.

2. An information processing apparatus comprising:
a first selector that selects, through a selecting operation performed by an operator, an item disposed within a quality function deployment chart, the quality function deployment chart having at least three axes, an item being associated with each of the axes, a name being appended to each of the axes, and a name being appended to each of the items; and
a search unit that searches for, on the basis of a name of an axis corresponding to the item selected by the first selector and a name of the item, information to which the name of the axis and the name of the item are appended by another information processing apparatus.

3. An information processing apparatus comprising:
a first selector that selects, through a selecting operation performed by an operator, an element forming a matrix disposed within a quality function deployment chart, the quality function deployment chart having at least three axes, an item being associated with each of the axes, a name being appended to each of the axes, a name being appended to each of the items, and the matrix which indicates relationships between items being deployed between two axes of the quality function deployment chart;
a second selector that selects, through a selecting operation performed by the operator, information related to the element selected by the first selector; and
an appending unit that appends, to the information selected by the second selector, a name of a first axis corresponding to the element selected by the first selector, a name of a first item which is disposed within the first axis and which corresponds to the element, a name of a second axis corresponding to the element, and a name of a second item which is disposed within the second axis and which corresponds to the element.

4. An information processing apparatus comprising:
a first selector that selects, through a selecting operation performed by an operator, an element forming a matrix disposed within a quality function deployment chart, the quality function deployment chart having at least three axes, an item being associated with each of the axes, a name being appended to each of the axes, a name being appended to each of the items, and the matrix which indicates relationships between items being deployed between two axes of the quality function deployment chart; and
a search unit that searches for, on the basis of a name of a first axis corresponding to the element selected by the first selector, a name of a first item which is disposed within the first axis and which corresponds to the element, a name of a second axis corresponding to the element, and a name of a second item which is disposed within the second axis and which corresponds to the element, information to which the name of the first axis, the name of the first item, the name of the second axis, and the name of the second item are appended by another information processing apparatus.

5. An information processing method comprising:
selecting, through a selecting operation performed by an operator, an item disposed within a quality function deployment chart, the quality function deployment chart having at least three axes, an item being associated with each of the axes, a name being appended to each of the axes, and a name being appended to each of the items;
selecting, through a selecting operation performed by the operator, information related to the selected item; and
appending a name of an axis corresponding to the selected item and a name of the selected item to the selected information.

6. An information processing method comprising:
selecting, through a selecting operation performed by an operator, an item disposed within a quality function deployment chart, the quality function deployment chart having at least three axes, an item being associated with each of the axes, a name being appended to each of the axes, and a name being appended to each of the items; and
searching for, on the basis of a name of an axis corresponding to the selected item and a name of the selected item, information to which the name of the axis and the name of the item are appended.

7. An information processing method comprising:
selecting, through a selecting operation performed by an operator, an element forming a matrix disposed within a quality function deployment chart, the quality function deployment chart having at least three axes, an item being associated with each of the axes, a name being appended to each of the axes, a name being appended to each of the items, and the matrix which indicates relationships between items being deployed between two axes of the quality function deployment chart;
selecting, through a selecting operation performed by the operator, information related to the selected element; and
appending, to the selected information, a name of a first axis corresponding to the selected element, a name of a first item which is disposed within the first axis and which corresponds to the element, a name of a second axis corresponding to the element, and a name of a second item which is disposed within the second axis and which corresponds to the element.

8. An information processing method comprising:
selecting, through a selecting operation performed by an operator, an element forming a matrix disposed within a quality function deployment chart, the quality function deployment chart having at least three axes, an item being associated with each of the axes, a name being appended to each of the axes, a name being appended to each of the items, and the matrix which indicates relationships between items being deployed between two axes of the quality function deployment chart; and
searching for, on the basis of a name of a first axis corresponding to the selected element, a name of a first item which is disposed within the first axis and which corresponds to the element, a name of a second axis corresponding to the element, and a name of a second item which is disposed within the second axis and which corresponds to the element, information to which the name of the first axis, the name of the first item, the name of the second axis, and the name of the second item are appended.

9. A non-transitory computer readable medium storing a program causing a computer to execute a process, the process comprising:
selecting, through a selecting operation performed by an operator, an item disposed within a quality function deployment chart, the quality function deployment chart having at least three axes, an item being associated with each of the axes, a name being appended to each of the axes, and a name being appended to each of the items;
selecting, through a selecting operation performed by the operator, information related to the selected item; and
appending a name of an axis corresponding to the selected item and a name of the selected item to the selected information.

10. A non-transitory computer readable medium storing a program causing a computer to execute a process, the process comprising:
selecting, through a selecting operation performed by an operator, an item disposed within a quality function deployment chart, the quality function deployment chart having at least three axes, an item being associated with each of the axes, a name being appended to each of the axes, and a name being appended to each of the items; and
searching for, on the basis of a name of an axis corresponding to the selected item and a name of the selected item, information to which the name of the axis and the name of the item are appended.

11. A non-transitory computer readable medium storing a program causing a computer to execute a process, the process comprising:
selecting, through a selecting operation performed by an operator, an element forming a matrix disposed within a quality function deployment chart, the quality function deployment chart having at least three axes, an item being associated with each of the axes, a name being appended to each of the axes, a name being appended to each of the items, and the matrix which indicates relationships between items being deployed between two axes of the quality function deployment chart;
selecting, through a selecting operation performed by the operator, information related to the selected element; and
appending, to the selected information, a name of a first axis corresponding to the selected element, a name of a first item which is disposed within the first axis and which corresponds to the element, a name of a second axis corresponding to the element, and a name of a second item which is disposed within the second axis and which corresponds to the element.

12. A non-transitory computer readable medium storing a program causing a computer to execute a process, the process comprising:
selecting, through a selecting operation performed by an operator, an element forming a matrix disposed within a quality function deployment chart, the quality function deployment chart having at least three axes, an item being associated with each of the axes, a name being appended to each of the axes, a name being appended to each of the items, and the matrix which indicates relationships between items being deployed between two axes of the quality function deployment chart; and
searching for, on the basis of a name of a first axis corresponding to the selected element, a name of a first item which is disposed within the first axis and which corresponds to the element, a name of a second axis corresponding to the element, and a name of a second item which is disposed within the second axis and which corresponds to the element, information to which the name of the first axis, the name of the first item, the name of the second axis, and the name of the second item are appended.
